(19) United States
(12) Patent Application Publication
(10) Pub. No.: US 2025/0103904 A1
(43) Pub. Date: Mar. 27, 2025

(54) FIRST NODE, THIRD NODE, FIFTH NODE AND METHODS PERFORMED THEREBY FOR HANDLING AN ONGOING DISTRIBUTED MACHINE-LEARNING OR FEDERATED LEARNING PROCESS

(71) Applicant: Telefonaktiebolaget LM Ericsson (publ), Stockholm (SE)

(72) Inventors: Jing YUE, Danderyd (SE); Zhang FU, Stockholm (SE); Ulf MATTSSON, Kungsbacka (SE); Mirko D'ANGELO, Göteborg (SE)

(21) Appl. No.: 18/728,841

(22) PCT Filed: Jan. 23, 2023
(86) PCT No.: PCT/EP2023/051495

§ 371 Date: Jul. 12, 2024

Related U.S. Application Data
(60) Provisional application No. 63/303,822, filed on Jan. 27, 2022.

(51) Int. Cl. G06N 3/098

(52) U.S. Cl. CPC G06N 3/098

(57) ABSTRACT

A computer-implemented method, performed by a first node. The method is for handling an ongoing distributed machine-learning or federated learning (DML/FL) process for which the first node acts an aggregator of data or analytics from a first group of second nodes. The first node operates in a communications system. The first node obtains one or more first indications about one or more third nodes. The one or more first indications include respective information about the third nodes. The respective information indicates that the third nodes are eligible to be selected to participate in the ongoing DML/FL process. The one or more first indications are obtained during the ongoing DML/FL process. The first node then provides, to a fourth node operating in the communications system, an output of the ongoing DML/FL process based on the obtained one or more first indications.

### TECHNICAL FIELD

The present disclosure relates generally to a first node and methods performed thereby for handling an ongoing distributed machine-learning or federated learning process. The present disclosure also relates generally to a third node, and methods performed thereby for handling an ongoing distributed machine-learning or federated learning process. The present disclosure further relates generally to a fifth node, and methods performed thereby, for handling an ongoing distributed machine-learning or federated learning process.

### BACKGROUND

Computer systems in a communications network or communications system may comprise one or more network nodes. A node may comprise one or more processors which, together with computer program code may perform different functions and actions, a memory, a receiving port, and a sending port. A node may be, for example, a server. Nodes may perform their functions entirely on the cloud.

The communications system may cover a geographical area which may be divided into cell areas, each cell area being served by a type of node, a network node in the Radio Access Network (RAN), radio network node or Transmission Point (TP), for example, an access node such as a Base Station (BS), e.g. a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also be comprised network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-Universal Terrestrial Radio Access (UTRA), as well as a Fifth Generation (5G) Packet Core Network, which may be referred to as 5G Core Network (5GC), abbreviated as 5GC.

### Distributed Machine Learning and Federated Learning

### Distributed Machine Learning

In Distributed Machine Learning (DML), the training process may be carried out using distributed resources, which may significantly accelerate the training speed and reduce the training time [1]. DML may relieve congestion in wireless networks by sending a limited amount of data to central servers for a training task, while protecting sensitive information and preserving data privacy of the devices in wireless networks.

Parameter Server (PS) framework may be understood as the underlying architecture of centrally assisted DML. FIG. 1 is a schematic diagram depicting an illustration of the Parameter Server architecture. As shown in FIG. 1, there may be two kinds of nodes in a PS framework: a server and a client or worker. There may be one or multiple servers. In the non-limiting example of FIG. 1, there are four server nodes. The client nodes may be partitioned into groups. In the non-limiting example of FIG. 1, there are twelve client nodes partitioned into three groups. The servers may be understood to maintain the whole or part of all parameters and aggregate the weights from each client group [1]. The client nodes may conduct the initial steps of a learning algorithm based on their access to training data and may use the synchronized global gradient from the server nodes to carry out back propagation and weight refreshments. For example, the clients may receive from the server nodes the weights w of the different features of an ML model and send back the respective weight refreshments as Δw. The servers may then update the weights as w′=w−ηΔw. The clients may only share the parameters with the servers, and never communicate with each other. The PS architecture has been broadly applied to decentralize ML tasks on wired platforms.

The existing studies on DML have been heavily focused on Federated Learning (FL), a popular architecture of DML for decentralized generation of generic ML models, its related technologies and protocols, and several application scenarios [2].

### Federated Learning

Federated learning (FL) may be understood as a distributed machine learning approach. As introduced in [3]. FL may be understood to enable the collaborative training of machine learning models among different organizations under the privacy restrictions. The main idea of FL may be understood to be to build machine learning models based on data sets that may be distributed across multiple devices while preventing data leakage [4]. In a federated learning system, multiple parties may collaboratively train machine learning models without exchanging their raw data. The output of the system may be a machine learning model for each party, which may be same or different [3].

There may be understood to be three major components in a federated learning system, that is, parties, e.g., clients, manager, e.g., server, and a communication-computation framework to train the machine learning model [3]. The parties may be understood to be the data owners and the beneficiaries of FL. The manager may be a powerful central server or one of the organizations who may dominate the FL process under different settings. Computation may happen on the parties and the manager, and communication may take place between the parties and the manager. Usually, the aim of the computation is for the model training, and the aim of the communication may be for exchanging the model parameters.

A basic and widely used framework in Federated learning is Federated Averaging (FedAvg) [5] (H. McMahan, E. Moore, D. Ramage, S. Hampson, et al. “Communication-efficient learning of deep networks from decentralized data.” arXiv preprint arXiv: 1602.05629, 2016.) as shown in the schematic diagram of FIG. 2 [3]. In each iteration, the process for FL may be as follows. First, as depicted by the number 1 in the Figure, the server may send the current global model to the selected parties. Then, as depicted by the number 2 in the Figure, the selected parties may update the global model with their local data. Next, as depicted by the number 3 in the Figure, the updated models may be sent back to the server. Last, as depicted by the number 4 in the Figure, the server may average all the received local models to get a new global model.

FedAvg may be understood to repeat the above process until reaching the specified number of iterations or the result of loss function may be lower than a threshold. The global model of the server may be understood to be the final output [3] [4].

### Federated Learning Among Multiple NWDAF Instances

In TR 23.700-91 v. 17.0.0, clause 6.24, a solution based on Federated Learning (FL) is given for Key Issue #2: Multiple Network Data Analytics Function (NWDAF) instances and Key Issue #19: Trained data model sharing between multiple NWDAF instances. As shown in the schematic diagram of FIG. 3, which corresponds to Figure 6.24.1.1-1 of TR 23.700-91 v. 17.0.0, and which depicts a hierarchical NWDAF deployment in a PLMN, multiple NWDAF may be deployed in a big Public Land Mobile Network (PLMN). Therefore, it may be difficult for a NWDAF to centralize all the raw data that may be distributed in different areas. However, it may be desired or reasonable for the NWDAF distributed in an area to share its model or data analytics with others NWDAFs.

Federated Learning, also referred to as Federated Machine Learning, may be a possible solution to handle the issues such as data privacy and security, model training efficiency, etc., in which there may be understood to be no need for raw data transferring, e.g., centralized into a single NWDAF, but only need for model sharing. For example, with multiple level NWDAF architecture, NWDAFs may be co-located with a 5GC Network Function (NF), e.g., a User Plane Function (UPF), or a Session Management Function (SMF), and the raw data cannot be exposed due to privacy concerns and performance reasons. In such case, the federated learning may be understood to be a good way to allow a Server NWDAF to coordinate with multiple localized NWDAFs to complete a machine learning.

The main idea of Federated Learning may be understood to be to build machine-learning models based on data sets that may be distributed in different network functions. A client NWDAF, e.g., deployed in a domain or network function, may locally train the local ML model with its own data, and share it to the server NWDAF. With local ML models from different client NWDAFs, the server NWDAF may aggregate them into a global or optimal ML model or ML model parameters and send them back to the client NWDAFs for inference.

This solution, that is, Solution #24 given in TR 23.700-91 v. 17.0.0, clause 6.24, tries to involve the idea of Federated Learning into the NWDAF-based architecture, which aims to investigate the following aspects: a) registration and discovery of multiple NWDAF instances that support Federated Learning; and b) how to share the ML models or ML model parameters during the Federated Learning training procedure among multiple NWDAF instances.

FIG. 4 is a signalling diagram corresponding to Figure 6.24.1.2-1 of TR 23.700-91 v. 17.0.0 and depicts the general procedure for Federated Learning among Multiple NWDAF Instances. In steps 1-3, client NWDAF may individually register their respective NF profile, e.g., client NWDAF Type, see TS 23.502, v17.3.0 clause 5.2.7.2.2, Address of Client NWDAF, Support of Federated Learning capability information, and Analytics ID(s), into the Network Repository Function (NRF). In steps 4-6, a server NWDAF may discover one or multiple client NWDAF instances which may be used for Federated Learning via the NRF, to get Internet Protocol (IP) addresses of client NWDAF instances, by invoking the Nnrf_NFDiscovery_Request service operation with Analytics ID and Support of Federated Learning capability information.

In FIG. 4, it is assumed that an Analytics ID is preconfigured for a type of Federated Learning. Thus, the NRF may realize the Server NWDAF is requesting to perform federated learning based on the pre-configuration. And the NRF may respond to the central NWDAF the IP address of multiple NWDAF instances which may support the Analytics ID. The Analytics ID(s) supporting Federated Learning may be configured by operator. In step 7a, each client NWDAF may communicate licensing conditions for its data and training infrastructure to participate in the federated learning task. These conditions may be based on policies set-up based on how sensitive the data may be, how much compute may be expected to be needed to perform local training, who may get the use the trained model, etc. In step 7b, based on the response from the NRF, the server NWDAF may select which NWDAF clients may participate based on its desired license model. In step 7c, the server NWDAF may send a request to the selected client NWDAFs that may participate in the Federated learning according to steps 7a and 7b including some parameters, e.g., such as initial ML model, data type list, maximum response time window, etc., to help the local model training for Federated Learning. In step 8, each client NWDAF may collect its local data by using the current mechanism in clause 6.2, TS 23.288, v. 17.3.0 [8]. In step 9, during the Federated Learning training procedure, each client NWDAF may further train the retrieved ML model from the server NWDAF based on its own data and report the results of ML model training to the Server NWDAF, e.g., the gradient. The server NWDAF may interact with the client NWDAF to deliver and update the ML model. How to transfer the ML model and local ML model training results is up to the conclusion of KI #19 in TR 23.700-91, v. 17.0.0. In step 10, the server NWDAF may aggregate all the local ML model training results retrieved at step 9, such as the gradient, to update the global ML model. In step 11, the server NWDAF may send the aggregated ML model information, updated ML model, to each client NWDAF for the next round model training. In step 12, each client NWDAF may update its own ML model based on the aggregated model information, updated ML model, distributed by the Server NWDAF at step 11. The steps 8-12 may be repeated until the training termination condition, e.g., maximum number of iterations, or the result of loss function is lower than a threshold, is reached. After the training procedure is finished, the globally optimal ML model or ML model parameters may be distributed to the client NWDAFs for the inference.

Analytics Aggregation from Multiple NWDAFs

In TS 23.288 v. 17.3.0, clause 6.1A, Analytics aggregation from multiple NWDAFs is described. In a multiple NWDAF deployment scenario, an NWDAF instance may be specialized to provide analytics for one or more analytics IDs. Each of the NWDAF instances may serve a certain area of interest or Tracking Area Identit(ies) (TAI(s)). Multiple NWDAFs may collectively serve the particular Analytics ID. An NWDAF may have the capability to support the aggregation of analytics, e.g., per Analytics ID, received from other NWDAFs, possibly with analytics generated by itself. The procedure for analytics aggregation from multiple NWDAFs may be as defined in clause 6.1A.3 of TS 23.288 v. 17.3.0, reproduced below under the subheading “Procedure for Analytics Aggregation”.

### Analytics Aggregation

The analytics aggregation from multiple NWDAFs may be used to address cases where an NWDAF service consumer may request Analytics ID(s) that may require multiple NWDAFs that may collectively serve the request. An aggregator NWDAF or aggregation point may be understood as an NWDAF instance with additional capabilities to aggregate output analytics provided by other NWDAFs. This may be understood to be in addition to regular NWDAF behavior, such as collecting data from other data sources to be able to generate its own output analytics. The aggregator NWDAF may be understood to be able to divide the area of interest received from the consumer info sub area of interest based on the serving area of each NWDAF to be requested for data analytics, and then send data analytics requests including the sub area of interest as an Analytics Filter to corresponding NWDAFs. The aggregator NWDAF may maintain information on the discovered NWDAFs, their supported Analytics IDs and NWDAF serving areas. The aggregator NWDAF may have “analytics aggregation capability” registered in its NF Profile within the NRF. The aggregator NWDAF may support the requesting and exchange of “Analytics Metadata Information” between NWDAFs when required for the aggregation of output analytics. “Analytics Metadata Information” may be understood as additional information associated with the requested Analytics ID(s) as defined in clause 6.1.3 of TS 23.288 v. 17.3.0. The aggregator NWDAF may also support dataset statistical properties, output strategy, and data time window parameters per type of analytics, e.g., Analytics ID, as defined in clause 6.1.3 of TS 23.288 v. 17.3.0.

The NRF may store the NF Profile of the NWDAF instances, including “analytics aggregation capability” for aggregator NWDAFs and “analytics metadata provisioning capability” when supported by the NWDAF. The NRF may return the NWDAF(s) matching the attributes provided in the Nnrf_NFDiscovery_Request, as specified in clause 5.2.7.3 of TS 23.502, v. 17.3.0 [11].

An NWDAF service consumer may request or subscribe to receive analytics for one or more Analytic IDs in a given area of interest, as specified in clause 6.1 of TS 23.288 v. 17.3.0.

The NWDAF service consumer may use the discovery mechanism from NRF as defined in clause 6.3.13 of TS 23.501, v. 17.3.0 to identify NWDAFs with certain capabilities, e.g., analytics aggregation, covering certain area of interest, e.g., providing data/analytics for specific TAI(s).

The NWDAF service consumer may be able to differentiate and select the preferred NWDAF in case multiple NWDAFs may be returned based on its internal selection criteria, possibly considering registered capabilities and information in NRF.

Procedure for Analytics Aggregation with Provision of Area of Interest

The procedure for analytics aggregation depicted in the signalling diagram of FIG. 5, which corresponds to Figure 6.1A.3-1 of TS 23.288, v. 17.3.0, may be used to address cases where an NWDAF service consumer may request Analytics ID(s) for an area of interest that may require multiple NWDAFs that may collectively serve the request. In steps 1a-b, the NWDAF service consumer may discover the NWDAF via an NRF. The NWDAF may send a Nnrf_NFDiscovery_Request_request, message to the NRF requesting the NWDAF instances that may collectively cover the area of interest indicated in the request, e.g., Analytics ID 1, TAI-1, TAI-2, TAI-n. The NRF may return multiple NWDAF candidates matching the requested capabilities, area of interest, and supported Analytics ID(s) in a Nnrf_NFDiscovery_Request_response message with the candidate NWDAFs. The NWDAF service consumer may select an NWDAF, e.g., NWDAF 1, with analytics aggregation capability, e.g., aggregator NWDAF, based on its internal selection criteria, possibly considering registered NWDAF capabilities and information in NRF. In step 2, the NWDAF service consumer may invoke Nnwdaf_AnalyticsInfo_Request or Nnwdaf_AnalyticsSubscription_Subscribe service operation from the selected aggregator NWDAF, e.g., NWDAF 1. In the request, the NWDAF service consumer may provide the requested Analytics ID(s), e.g., Analytics ID 1, along with the required area of interest, e.g., TAI-1, TAI-2, TAI-n, if known to the NWDAF service consumer. In step 3, on receiving the request in step 2, the aggregator NWDAF, e.g., NWDAF 1, based on, e.g., configuration or queries to the NRF, and considering the request from the NWDAF service consumer, e.g., analytics filter information, may determine the other NWDAF instances that collectively may cover the area of interest indicated in the request, e.g., TAI-1, TAI-2, TAI-n. In the discovery request sent to the NRF, the aggregator NWDAF may indicate “analytics metadata provisioning capability”, e.g., as query parameter, thus, requesting to the NRF to reply back with, if available, those NWDAF instance(s) which may also support “analytics metadata provisioning capability” functionality as indicated during particular NWDAF instance registration procedure. In steps 4-5, the aggregator NWDAF, e.g., NWDAF 1, may invoke Nnwdaf_AnalyticsInfo_Request or Nnwdaf_AnalyticsSubscription_Subscribe service operation from each of the NWDAFs discovered/determined in step 3, e.g., NWDAF 2 and NWDAF 3. The request may optionally indicate “analytics metadata request” parameter to the determined NWDAFs, e.g., NWDAF 2 and/or NWDAF 3, when analytics metadata may be supported by these NWDAFs. The request or subscription to the determined NWDAFs, e.g., NWDAF 2 and/or NWDAF 3, may also include the dataset statistical properties, output strategy, and data time window. This may indicate to the determined NWDAFs that the Analytics ID output may need to be generated based on such parameters when requested. In steps 6-7a-b, the determined NWDAFs, e.g., NWDAF 2 and/or NWDAF 3, may reply or notify with the requested output analytics, by either sending a Nnwdaf_AnalyticsInfo_Request response or a Nnwdaf_AnalyticsSubscription_Notify message. If “analytics metadata request” was included in the request received by such NWDAF, in steps 4-5, the NWDAF may additionally return the “analytics metadata information” used for generating the analytics output as defined in clause 6.1.3 of TS 23.288 v. 17.3.0. In step 8, the aggregator NWDAF, e.g., NWDAF 1, may aggregate received analytics information, that is, it may generate a single output analytics based on the multiple analytics outputs and, optionally, the “analytics metadata information” received from the determined NWDAFs, e.g., NWDAF 2 and NWDAF 3. The aggregator NWDAF, e.g., NWDAF 1, may also take its own analytics for TAI-n into account for the analytics aggregation. In steps 9a-b, the aggregator NWDAF, e.g., NWDAF 1, may send a response or notify the NWDAF service consumer, by sending either a Nnwdaf_AnalyticsInfo_Request response or a Nnwdaf_AnalyticsSubscription_Notify message.

Once trained, and after certain periods of time, machine-learning models trained with existing methods for distributed machine-learning or federated learning in a communications system may lose accuracy or may require to be discarded and replaced with new models, which may involve a waste of computing and time resources.

### SUMMARY

As part of the development of embodiments herein, one or more challenges with the existing technology will first be identified and discussed.

In the course of operations of a federation network, changes may dynamically occur. For example, due to the dynamic changes, current Client NWDAFs for an ongoing distributed machine-learning or federated learning process may not be able to provide sufficient computation resource after a period of use or may not be able to access a further training dataset, which may be understood to lead to a decrease in the training speed and to performance degradation of the trained model or analytics. Meanwhile, stragglers, that is, less capable or weaker Client NWDAFs, may cause the learning/training process to terminate prematurely. In these cases, an NWDAF may be be unable to provide stable and high-quality services to an NWDAF service consumer.

In order to adapt an FL ML model to dynamic network changes, a new FL ML training process may need to be started from scratch, so that a new model that may be able to predict the network feature of interest may be accurately predicted given the changed circumstances.

According to the foregoing, it is an object of embodiments herein to improve the handling of a distributed machine-learning or federated learning process. Particularly, embodiments herein are drawn to the dynamic addition of new client NWDAF(s) to a DML/FL multi-round learning/training process in 5GC, as they may be needed. The solution in TR 23.700-91, v. 17.0.0 for FL among multiple NWDAF instances, e.g., Solution #24, did not consider the dynamic addition of new NWDAF(s) during DML/FL processes. The procedures for dynamic addition of new client NWDAF(s) to DML/FL during the multi-round learning/training processes in 5GC are also void in TS 23.288, v. 17.3.0.

According to a first aspect of embodiments herein, the object is achieved by a computer-implemented method, performed by a first node. The method is for handling an ongoing distributed machine-learning or federated learning process for which the first node acts an aggregator of data or analytics from a first group of second nodes. The first node operates in a communications system. The first node obtains one or more first indications. The one or more first indications are about one or more third nodes operating in the communications system. The one or more first indications comprise respective information about the one or more third nodes. The respective information indicates that the one or more third nodes are eligible to be selected to participate in the ongoing distributed machine-learning or federated learning process. The one or more first indications are obtained during the ongoing distributed machine-learning or federated learning process. The first node also provides, to a fourth node operating in the communications system, an output of the ongoing distributed machine-learning or federated learning process. The output is based on the obtained one or more first indications.

According to a second aspect of embodiments herein, the object is achieved by a computer-implemented method, performed by the third node. The method is for handling the ongoing distributed machine-learning or federated learning process. The third node operates in the communications system. The third node provides the first indication about the third node to one of the first node and a fifth node operating in the communications system. The first node acts an aggregator of data or analytics from the first group of second nodes in the ongoing distributed machine-learning or federated learning process. The first indication comprises respective information about the third node. The respective information indicates that the third node is eligible to be selected to participate in the ongoing distributed machine-learning or federated learning process. The first indication is provided during the ongoing distributed machine-learning or federated learning process.

According to a third aspect of embodiments herein, the object is achieved by a computer-implemented method, performed by the fifth node. The method is for handling the ongoing distributed machine-learning or federated learning process. The fifth node operates in the communications system. The fifth node obtains the one or more first indications from the one or more third nodes operating in the communications system. The one or more first indications comprise the respective information indicating that the one or more third nodes are eligible to be selected to participate in the ongoing distributed machine-learning or federated learning process. The one or more first indications are obtained during the ongoing distributed machine-learning or federated learning process. The fifth node also provides the one or more first indications to the first node operating in the communications system. The first node acts as the aggregator of data or analytics from the first group of second nodes for the ongoing distributed machine-learning or federated learning process. The one or more first indications are provided during the ongoing distributed machine-learning or federated learning process.

According to a fourth aspect of embodiments herein, the object is achieved by the first node, for handling the distributed machine-learning or federated learning process configured to be ongoing, for which the first node is configured to act the aggregator of data or analytics from the first group of second nodes. The first node is configured to operate in the communications system. The first node is further configured to obtain the one or more first indications about the one or more third nodes configured to operate in the communications system. The one or more first indications are configured to comprise the respective information about the one or more third nodes. The respective information is configured to indicate that the one or more third nodes are eligible to be selected to participate in the distributed machine-learning or federated learning process configured to be ongoing. The one or more first indications are configured to be obtained during the distributed machine-learning or federated learning process configured to be ongoing. The first node is further configured to provide, to the fourth node configured to operate in the communications system, the output of the distributed machine-learning or federated learning process configured to be ongoing. The output is configured to be based on the one or more first indications configured to be obtained.

According to a fifth aspect of embodiments herein, the object is achieved by the third node, for handling the distributed machine-learning or federated learning process configured to be ongoing. The third node is configured to operate in the communications system. The third node is further configured to provide the first indication about the third node to one of the first node and the fifth node configured to operate in the communications system. The first node is configured to act the aggregator of data or analytics from the first group of second nodes in the distributed machine-learning or federated learning process configured to be ongoing. The first indication is configured to comprise the respective information about the third node. The respective information is configured to indicate that the third node is eligible to be selected to participate in the distributed machine-learning or federated learning process configured to be ongoing. The first indication is configured to be provided during the distributed machine-learning or federated learning process configured to be ongoing.

According to a sixth aspect of embodiments herein, the object is achieved by the fifth node, for handling the distributed machine-learning or federated learning process configured to be ongoing. The fifth node is configured to operate in the communications system. The fifth node is further configured to obtain the one or more first indications from the one or more third nodes configured to operate in the communications system. The one or more first indications may be configured to comprise the respective information configured to indicate that the one or more third nodes are eligible to be selected to participate in the distributed machine-learning or federated learning process configured to be ongoing. The one or more first indications are configured to be obtained during the distributed machine-learning or federated learning process configured to be ongoing. The fifth node is further configured to provide the one or more first indications to the first node configured to operate in the communications system. The first node is configured to act as the aggregator of data or analytics from the first group of second nodes for the distributed machine-learning or federated learning process configured to be ongoing. The one or more first indications are configured to be provided during the distributed machine-learning or federated learning process configured to be ongoing.

By the first node obtaining the one or more first indications, the first node may be enabled to dynamically consider whether or not to select any of the one or more third nodes in order to continue the ongoing distributed machine-learning or federated learning process. This may then enable the first node to expedite the training of the ongoing distributed machine-learning or federated learning process and/or to increase the accuracy of any resulting machine-learning model and/or to avoid that the learning/training may terminate due to stragglers. The first node may then in turn be enabled to provide an output of the ongoing distributed machine-learning or federated learning process to the fourth node, e.g., the consumer of the service provided by the first node.

By providing the output of the ongoing distributed machine-learning or federated learning process to the fourth node in this Action, the first node may enable the fourth node to obtain the machine-learning model or analytics based on the model in an expedited fashion and/or with increased accuracy.

By the third node providing the first indication about the third node during the ongoing distributed machine-learning or federated learning process, the first node may be enabled to consider if the third node may be dynamically selected to be used to continue the ongoing distributed machine-learning or federated learning process, enabling the advantages described above.

By the fifth node obtaining the one or more first indications from one or more third nodes operating in the communications system during the ongoing distributed machine-learning or federated learning process, and then providing the one or more first indications to the first node the first node may be enabled to consider if the one or more third nodes may be dynamically selected to be used to continue the ongoing distributed machine-learning or federated learning process, enabling the advantages described above.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a Parameter Server architecture, according to existing methods.

FIG. 2 is a schematic diagram illustrating a non-limiting example of Federated Averaging (FedAvg), according to existing methods.

FIG. 3 is a schematic diagram depicting embodiments of a hierarchical NWDAF deployment in a PLMN, according to existing methods described in Figure 6.24.1.1-1 of TR 23.700-91 v. 17.0.0.

FIG. 4 is a signalling diagram depicting the general procedure for Federated Learning among Multiple NWDAF Instances, according to existing methods described in Figure 6.24.1.2-1 of TR 23.700-91 v. 17.0.0.

FIG. 5 is a signalling diagram depicting embodiments of a procedure for analytics aggregation, according to existing methods.

FIG. 6 is a schematic diagram illustrating a non-limiting example of a communications system, according to embodiments herein.

FIG. 7 is a flowchart depicting embodiments of a method in a first node, according to embodiments herein.

FIG. 8 is a flowchart depicting embodiments of a method in a third node, according to embodiments herein.

FIG. 9 is a flowchart depicting embodiments of a method in a fifth node, according to embodiments herein.

FIG. 10 is a schematic diagram depicting a non-limiting example of signalling between nodes in a communications system, according to embodiments herein.

FIG. 11 is a schematic block diagram illustrating two non-limiting examples, a) and b), of a first node, according to embodiments herein.

FIG. 12 is a schematic block diagram illustrating two non-limiting examples, a) and b), of a third node, according to embodiments herein.

FIG. 13 is a schematic block diagram illustrating two non-limiting examples, a) and b), of a fifth node, according to embodiments herein.

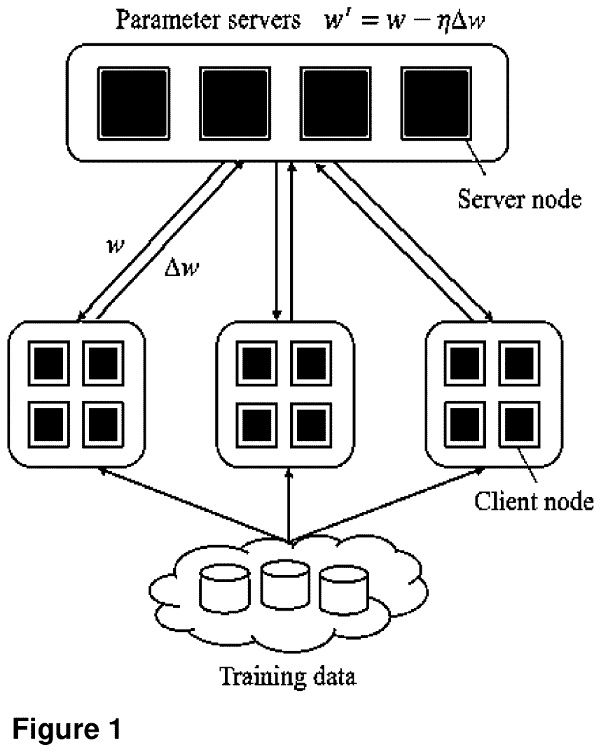

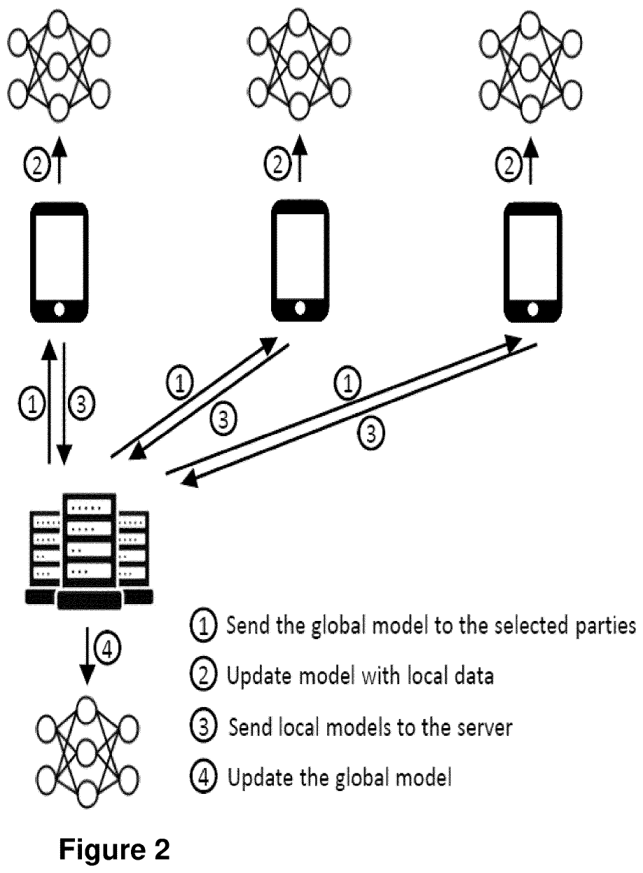

### DETAILED DESCRIPTION

Certain aspects of the present disclosure and their embodiments address one or more of the challenges identified with the existing methods and provide solutions to the challenges discussed.

Embodiments herein may relate to dynamic addition of client NWDAF(s) during distributed/federated learning processes in 5G core network. As a summarized overview, embodiments herein may be understood to provide procedure for the dynamic addition of new Client NWDAF(s) during the multi-round DML/FL learning/training processes in 5GC. Two different cases are considered which may enable a server NWDAF to get the information of new client NWDAF(s). That is, from the new client NWDAF(s) directly, or via a DML/FL control function (DLCF), e.g., NRF, Data Collection Coordination Function (DCCF), etc. Procedures for dynamic addition of new client NWDAF(s) to DML/FL in the two cases are given separately.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

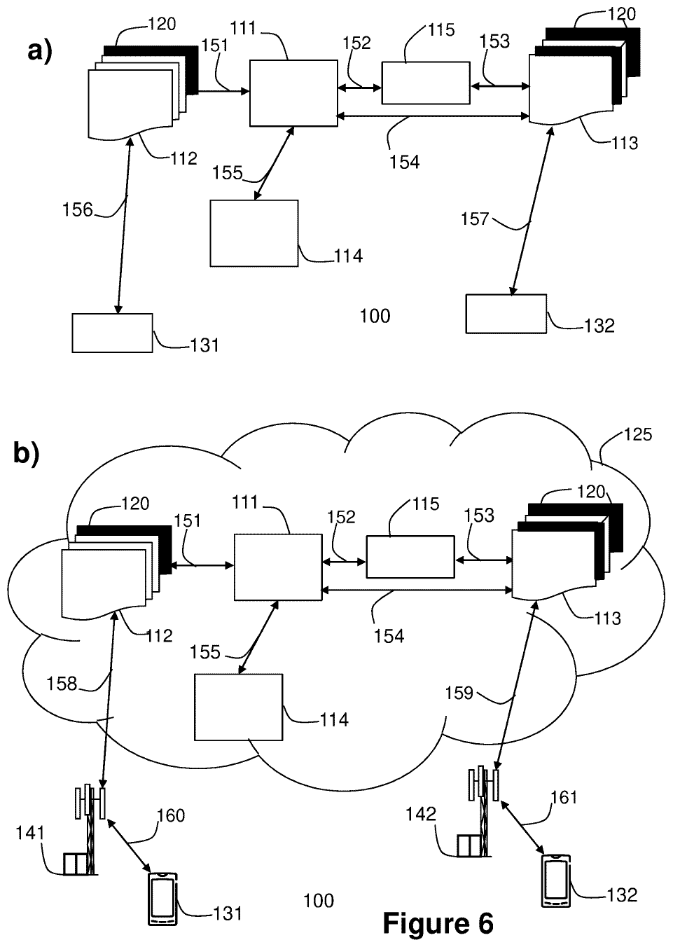

FIG. 6 depicts two non-limiting examples, in panels “a” and “b”, respectively, of a communications system 100, in which embodiments herein may be implemented. In some example implementations, such as that depicted in the non-limiting example of FIG. 6a, the communications system 100 may be a computer network. In other example implementations, such as that depicted in the non-limiting example of FIG. 6b, the communications system 100 may be implemented in a telecommunications system, sometimes also referred to as a telecommunications network, cellular radio system, cellular network, or wireless communications system. In some examples, the telecommunications system may comprise network nodes which may serve receiving nodes, such as wireless devices, with serving beams.

In some examples, the telecommunications system may for example be a network such as a 5G system, or a newer system supporting similar functionality. The telecommunications system may also support other technologies, such as a Long-Term Evolution (LTE) network, e.g., LTE Frequency Division Duplex (FDD), LTE Time Division Duplex (TDD), LTE Half-Duplex Frequency Division Duplex (HD-FDD), or LTE operating in an unlicensed band, Wideband Code Division Multiple Access (WCDMA), UTRA TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc . . . , any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

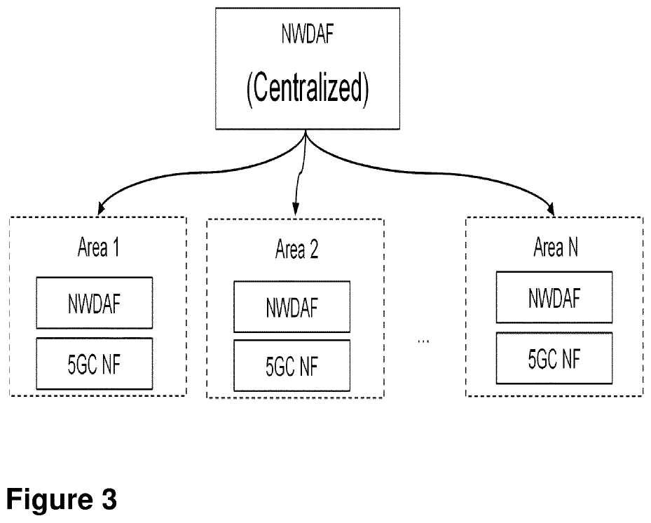

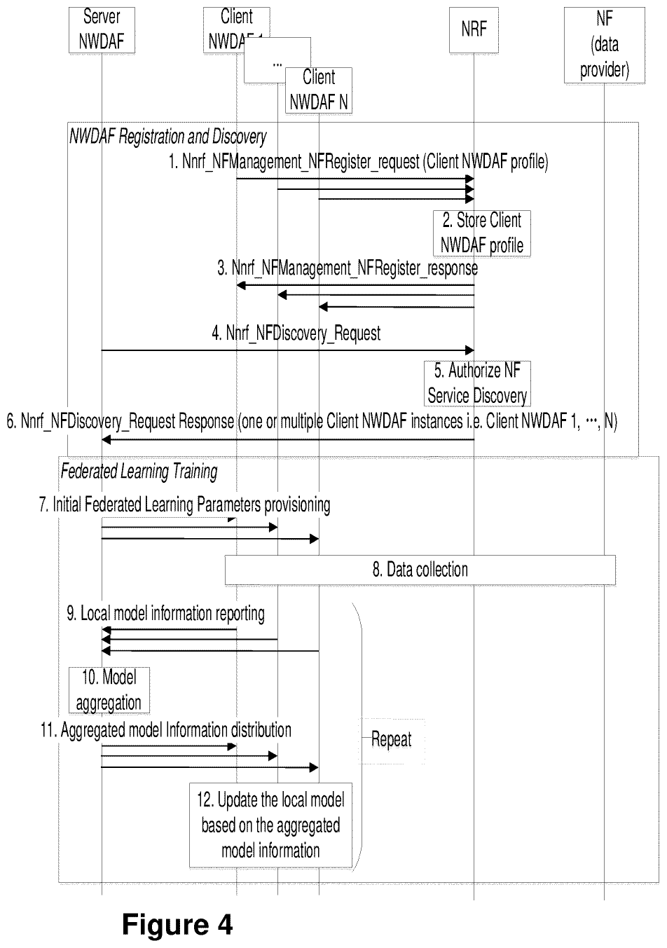

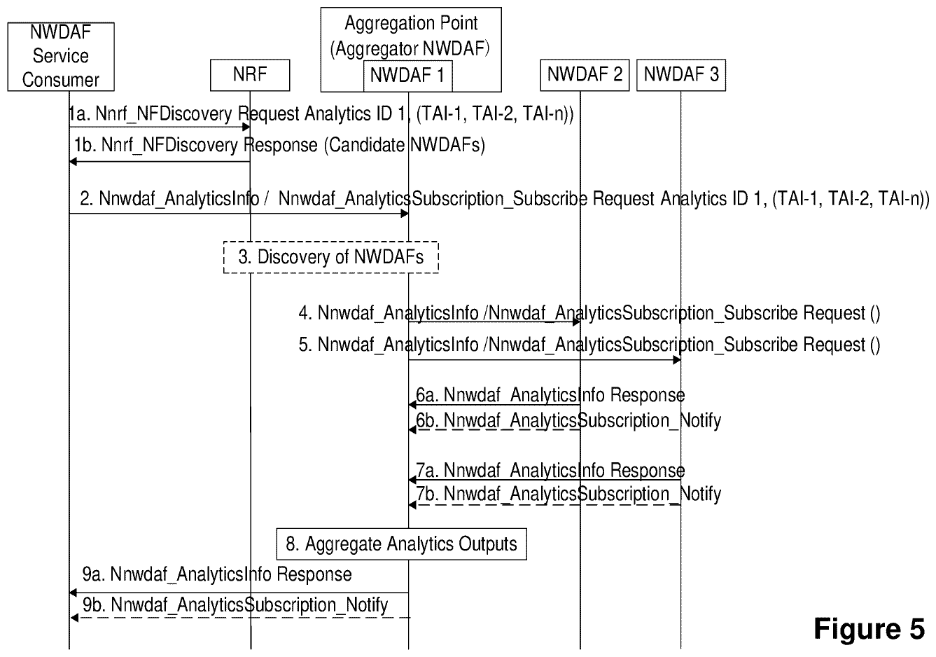

The communications system 100 may comprise a plurality of nodes, and/or operate in communication with other nodes, whereof a first node 111, a first group of second nodes 112, one or more third nodes, which may comprise at least one third node 113, a fourth node 114 and a fifth node 115, are depicted in FIG. 6. It may be understood that the communications system 100 may comprise more nodes than those represented on FIG. 6. In the non-limiting example of FIG. 6, the first group of second nodes 112 comprises four second nodes, and the one or more third nodes also comprise four third nodes. Out of the first group of second nodes 112 and the one or more third nodes 113, one or more selected nodes 120 may be selected as will be described later in embodiments herein in relation to FIG. 3. The one or more selected nodes 120 are depicted as filled in solid black.

Any of the first node 111, the first group of second nodes 112, the one or more third nodes 113, the fourth node 114, and the fifth node 115 may be understood, respectively, as a first computer system, a first group of second computer systems, one or more third computer systems, a fourth computer system and a fifth computer system. In some examples, any of the first node 111, the first group of second nodes 112, the one or more third nodes 113, the fourth node 114, and the fifth node 115 may be implemented as a standalone server in e.g., a host computer in the cloud 125, as depicted in the non-limiting example depicted in panel b) of FIG. 6. Any of the first node 111, the first group of second nodes 112, the one or more third nodes 113, the fourth node 114, and the fifth node 115 may in some examples be a distributed node or distributed server, with some of their respective functions being implemented locally, e.g., by a client manager, and some of its functions implemented in the cloud 120, by e.g., a server manager. Yet in other examples, any of the first node 111, the first group of second nodes 112, the one or more third nodes 113, the fourth node 114, and the fifth node 115 may also be implemented as processing resources in a server farm.

Any of the first node 111, the first group of second nodes 112, the one or more third nodes 113, the fourth node 114, and the fifth node 115 may be independent and separate nodes. Any of the first node 111, the first group of second nodes 112, the one or more third nodes 113, the fourth node 114, and the fifth node 115 may be co-localized or be the same node.

In some examples of embodiments herein, the first node 111 may be understood as a node that may have a capability to aggregate data or analytics from other nodes, such as for example, from the first group of second nodes 112, from any of the one or more third nodes 113 or from the one or more selected nodes 120. The first node 111 may further have a capability to analyze the aggregated the data or analytics, such as by performing operations of DML/FL processes on the aggregated data or analytics. Non-limiting examples of the first node 111 wherein the communications system 100 may be a 5G network, may be a server NWDAF.

Any of the second nodes in the first group of second nodes 112 may be a node having a capability to collect data from the communications system 100 and train a local model in a DML/FL process. In some particular examples wherein the communications system 100 may be a 5G network, any of the second nodes in the first group of second nodes 112 may be a first group of client NWDAFs.

Any of the one or more third nodes 113 may be a node with a same functional description as any of the second nodes in the first group of second nodes 112. In some particular examples, the one or more third nodes 113 may be other client NWDAFs.

The fourth node 114 may be a node having a capability to consume services provided by an analytics function in the communications system 100. In some particular examples wherein the communications system 100 may be a 5G network, the fourth node 114 may be a NWDAF service consumer.

The fifth node 115 may be a node having a capability to store data, e.g., grouped into distinct collections of subscription-related information, such as subscription data, policy data, structured data for exposure, and application data. The fifth node 115 may further have a capability to supply the data to another node, such as e.g., the first node 111 or any of the one or more third nodes 113, based on a request or a subscription. In some particular examples wherein the communications system 100 may be a 5G network, the fifth node 115 may be a DLCF, such as for example, an NRF or a Data Collection Coordination Function (DCCF).

The communications system 100 may comprise a plurality of devices, such as a first plurality of devices 131 and a second plurality of devices 132, each represented in FIG. 6 with a single device. The first plurality of devices 131 may be in a first area of interest and the second plurality of devices 132 may be in a second area of interest. Any of the devices 131, 132 may be also known as e.g., user equipment (UE), a wireless device, mobile terminal, wireless terminal and/or mobile station, mobile telephone, cellular telephone, or laptop with wireless capability, an Internet of Things (IoT) device, sensor, or a Customer Premises Equipment (CPE), just to mention some further examples. Any of the devices 131, 132 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, an Internet of Things (IoT) device, e.g., a sensor or a camera, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. Any of the devices 131, 132 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The communications system 100 may comprise one or more radio network nodes, whereof a first plurality of radio networks nodes 141 and a second plurality of radio networks nodes 142 is depicted in FIG. 6b. Any of the radio network nodes in the first plurality of radio networks nodes 141 or in the second plurality of radio networks nodes 142 may typically be a base station or Transmission Point (TP), or any other network unit capable to serve a wireless device or a machine type node in the communications system 100. Any of the radio network nodes in the first plurality of radio networks nodes 141 or in the second plurality of radio networks nodes 142 may be e.g., a 5G gNB, a 4G eNB, or a radio network node in an alternative 5G radio access technology, e.g., fixed or WiFi. Any of the radio network nodes in the first plurality of radio networks nodes 141 or in the second plurality of radio networks nodes 142 may be e.g., a Wide Area Base Station, Medium Range Base Station, Local Area Base Station and Home Base Station, based on transmission power and thereby also coverage size. Any of the radio network nodes in the first plurality of radio networks nodes 141 or in the second plurality of radio networks nodes 142 may be a stationary relay node or a mobile relay node. Any of the radio network nodes in the first plurality of radio networks nodes 141 or in the second plurality of radio networks nodes 142 may support one or several communication technologies, and its name may depend on the technology and terminology used. Any of the radio network nodes in the first plurality of radio networks nodes 141 or in the second plurality of radio networks nodes 142 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with any of the second nodes in the first group of second nodes 112 over a respective first link 151, e.g., a radio link or a wired link. Only one such link is depicted in FIG. 6 to simplify the figure. The first node 111 may communicate with the fifth node 115 over a second link 152, e.g., a radio link or a wired link. The fifth node 115 may communicate with any of the one or more third nodes 113 over a respective third link 153, e.g., a radio link or a wired link. Only one such link is depicted in FIG. 6 to simplify the figure. The first node 111 may communicate, directly or indirectly, with any of the one or more third nodes 113 over a respective fourth link 154, e.g., a radio link or a wired link. Only one such link is depicted in FIG. 6 to simplify the figure. The first node 111 may communicate with the fourth node 114 over a respective fifth link 155, e.g., a radio link or a wired link. Any of the second nodes in the first group of second nodes 112 may communicate, directly or indirectly with any of the devices in the first plurality of devices 131 over a respective sixth link 156, e.g., a radio link or a wired link. Only one such link is depicted in FIG. 6 to simplify the figure. Any of the one or more third nodes 113 may communicate, directly or indirectly with any of the devices in the second plurality of devices 132 over a respective seventh link 157, e.g., a radio link or a wired link. Only one such link is depicted in FIG. 6 to simplify the figure. Any of the second nodes in the first group of second nodes 112 may communicate, directly or indirectly with any of the radio network nodes in the first plurality of radio networks nodes 141 over a respective eighth link 158, e.g., a radio link or a wired link. Only one such link is depicted in FIG. 6 to simplify the figure. Any of the one or more third nodes 113 may communicate, directly or indirectly with any of the radio network nodes in the second plurality of radio network nodes 142 over a respective ninth link 159, e.g., a radio link or a wired link. Only one such link is depicted in FIG. 6 to simplify the figure. Any of the radio network nodes in the first plurality of radio networks nodes 141 may communicate, directly or indirectly with any of the devices in the first plurality of devices nodes 131 over a respective tenth link 160, e.g., a radio link or a wired link. Only one such link is depicted in FIG. 6 to simplify the figure. Any of the radio network nodes in the second plurality of radio network nodes 142 may communicate, directly or indirectly with any of the devices in the second plurality of devices 312 over a respective eleventh link 161, e.g., a radio link or a wired link. Only one such link is depicted in FIG. 6 to simplify the figure.

Any links mentioned above may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 6.

In general, the usage of “first”, “second”, “third”, “fourth”, “fifth”, “sixth”, “seventh”, “eighth”, “ninth”, “tenth” and/or “eleventh” herein may be understood to be an arbitrary way to denote different elements or entities and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

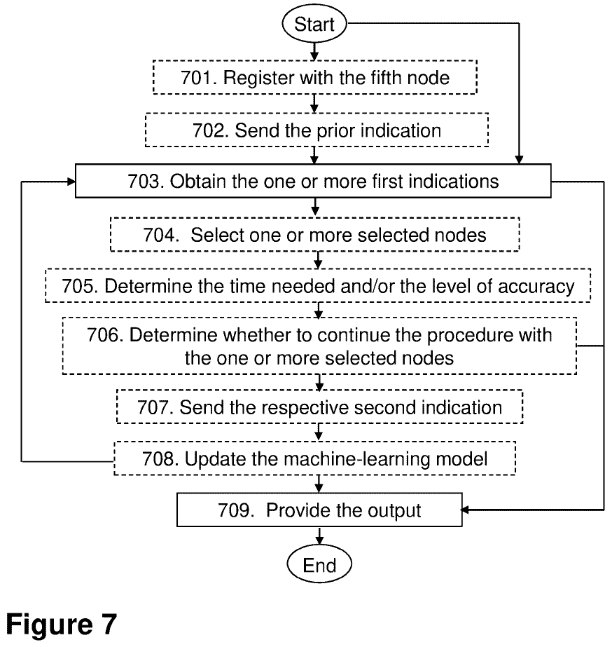

Embodiments of a computer-implemented method, performed by the first node 111, will now be described with reference to the flowchart depicted in FIG. 7. The method may be understood to be for handling an ongoing distributed machine-learning or federated learning process for which the first node 111 acts an aggregator of data or analytics from the first group of second nodes 112. The first node 111 operates in the communications system 100.

In some embodiments wherein the communications system 100 may be a Fifth Generation (5G) network, the first node 111 may be a server NWDAF, the first group of second nodes 112 may be client NWDAFs, the one or more third nodes 113 may be other client NWDAFs, the fourth node 114 may be a NWDAF service consumer, and the fifth node 115 may be a DLCF.

Several embodiments are comprised herein. The method may comprise the following actions. In some embodiments, all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first node 111 is depicted in FIG. 7.

In FIG. 7, optional actions are represented with dashed lines.

### Action 701

In this Action 701, the first node 111 may optionally register with the fifth node 115 first information. The first information may indicate the ongoing distributed machine-learning or federated learning process. The first information may indicate at least one of the following options. According to a first option, the first information may indicate an identifier of the ongoing distributed machine-learning or federated learning process, such as for example, an Analytics ID, and/or a DML/FL Correlation ID. According to a second option, the first information may indicate second information about the first group of second nodes 112 used for the ongoing distributed machine-learning or federated learning process, such as for example, client NWDAF(s) information.

By registering the first information with the fifth node 115 in this Action 701, other nodes such as the one or more third nodes 113 may be made aware of the ongoing distributed machine-learning or federated learning process and may be thereby enabled to inform the first node 111, or the fifth node 115, that they are eligible, e.g., willing and/or capable, to partake in the ongoing distributed machine-learning or federated learning process or provide other information that may be relevant to it. This may be particularly useful in situations wherein the one or more third nodes 113 may not know about the first node 111. By the first node 111 having registered the first information in a known repository such as the fifth node 115, the one or more third nodes 113 may dynamically access the first information via the fifth node 115.

### Action 702

In this Action 702, the first node 111 may send a prior indication to the fifth node 115. The prior indication may request one or more first indications. The one or more first indications comprise respective information about the one or more third nodes 113. The respective information may indicate that the one or more third nodes 113 may be eligible to be selected to participate in the ongoing distributed machine-learning or federated learning process. In other words, the first node 111 may ask the fifth node 115 to provide information about nodes that may be eligible to partake in the ongoing distributed machine-learning or federated learning process.

In some examples, the first node 111 may perform this Action 702 using a Request-Response mechanism, by sending the prior indication as a discovery request. As a further particular example wherein the first node 111 may be a server NWDAF and the fifth node 115 may be DLCF, the first node 111 may send a discovery request to a DLCF, e.g., an NRF. This may enable that the fifth node 115 may respond to the first node 111 with the information about the one or more third nodes 113, e.g., new client NWDAF(s).

In other examples, the first node 111 may perform this Action 702 using a Subscribe-Notify mechanism, by sending the prior indication as a subscription, so that the fifth node 115 may push information about the one or more third nodes 113. As a further particular example wherein the first node 111 may be a server NWDAF and the fifth node 115 may be DLCF, the first node 111 may subscribe to the fifth node 115, e.g., a DCCF. This may enable that the fifth node 115 may push the information about the one or more third nodes 113, e.g., new Client NWDAF(s) to the first node 111.

The sending, in this Action 702 may be performed e.g., via the second link 152.

This Action 702 may be performed during the ongoing distributed machine-learning or federated learning process. That is, any time after the first node 111 may have started the ongoing distributed machine-learning or federated learning process with the first group of second nodes 112. For example, during the provisioning of the initial FL parameters to the first group of second nodes 112, during data collection by the first group of second nodes 112, during the local model information reporting by the first group of second nodes 112, during the model aggregation of the local model information reported by the first group of second nodes 112, during the distribution of aggregated model information, or during any iteration of these processes.

By sending the prior indication in this Action 702, the first node 111 may be enabled to dynamically become aware of the availability of the one or more third nodes 113 to partake in the ongoing distributed machine-learning or federated learning process, and thereby be enabled to consider selecting any of them to partake in the ongoing distributed machine-learning or federated learning process. Adding any of the one or more third nodes 113 during the ongoing distributed machine-learning or federated learning process may be understood to enable to expedite the training of the ongoing distributed machine-learning or federated learning process and/or to increase the accuracy of any resulting machine-learning model and/or to avoid that the learning/training may terminate due to stragglers. This may be understood to be because the one or more third nodes 113 may be able to collect data from additional areas of interest than the first group of second nodes 112 thereby increasing the pool of data, or by providing data about areas of interest that the first group of second nodes 112 may not have access too, thereby enabling to explore the weight of factors not previously explored and because the one or more third nodes 113 may be able to provide extra computation resources, thereby enabling to avoid that the learning/training may terminate due to stragglers.

### Action 703

In this Action 703, the first node 111 obtains the one or more first indications about the one or more third nodes 113 operating in the communications system 100. The one or more first indications comprise respective information about the one or more third nodes 113. That is each of the first indications may comprise information about one of the one or more third nodes 113.

The respective information indicates that the one or more third nodes 113 are eligible to be selected to participate in the ongoing distributed machine-learning or federated learning process. The one or more first indications are obtained during the ongoing distributed machine-learning or federated learning process.

The respective information comprised in the one or more first indications may indicate, e.g., with respect to performing one or more training tasks of the ongoing distributed machine-learning or federated learning process, one or more of the following options. According to a first option, the respective information may indicate a respective willingness to join the ongoing distributed machine-learning or federated learning process, which may be identified for example with the DML/FL Correlation ID, and/or the Analytics ID. According to a second option, the respective information may indicate a respective first capability to complete one or more training tasks of the ongoing distributed machine-learning or federated learning process, e.g., available computation resource, achievable speed/required time for completing tasks, etc. According to a third option, the respective information may indicate one or more respective characteristics of available data to a respective third node 113, e.g., area of interest, stored previous analytics and/or training data and results, etc. According to a fourth option, the respective information may indicate a respective supported machine-learning framework, e.g., DML/FL, etc. According to a fifth option, the respective information may indicate a respective time availability to participate in the ongoing distributed machine-learning or federated learning process. That is, available time for participating in the next rounds of training, e.g., available time duration, etc. Some of the one or more third nodes 113 may only be available to participate in partial rounds of the rest of the training.

In particular examples, the one or more first indications may be a single willingness message which may include the following parameters: DML/FL Correlation ID, Analytics ID, Capability, Available data, Supported ML framework, and/or Available time for participate in the training, etc.

Respective may be understood to mean pertaining of one of the one or more third nodes 113.

The obtaining, e.g., receiving, in this Action 703 may be performed one of the following options. According to a first option, the obtaining in this Action 703 may be performed directly from, respectively, the one or more third nodes 113, e.g., via the respective fourth link 154. According to a second option, the obtaining in this Action 703 may be performed via the fifth node 115 operating in the communications system 100 the one or more third nodes 113 may have previously registered with.

In embodiments wherein the first node 111 may have performed Action 701, the obtaining in this Action 703 of the one or more first indications may be based on the registered first information. That is, the first node 111 may obtain, e.g., receive the one or more first indications after the first node 111 may have made the fifth node 115 aware of the ongoing distributed machine-learning or federated learning process, which may have in turn enabled the one or more third nodes 113 to become aware of it.

In embodiments wherein the first node 111 may have performed Action 702, the obtaining in this Action 703 of the one or more first indications may be based on the sent prior indication. That is, the first node 111 may obtain, e.g., receive the one or more first indications as a response to a request to the fifth node 115 or as a notification to a subscription with the fifth node 115.

By the first node 111 obtaining the one or more first indications in this Action 703, the first node 111 may then be enabled to dynamically consider whether or not to select any of the one or more third nodes 113 in order to continue the ongoing distributed machine-learning or federated learning process. This, as explained above, may enable the first node 111 to expedite the training of the ongoing distributed machine-learning or federated learning process and/or to increase the accuracy of any resulting machine-learning model and/or to avoid that the learning/training may terminate due to stragglers. The first node 111 may then be enabled to provide an output of the ongoing distributed machine-learning or federated learning process to the fourth node 114, that is the consumer of the service provided by the first node 111.

### Action 704

In this Action 704, the first node 111 may select, based on the received respective one or more first indications, from the first group of second nodes 112, e.g., 1 to N, and the one or more third nodes 113, e.g., N+1 to N+X, that is, may select from N+X, one or more selected nodes 120 to continue the ongoing distributed machine-learning or federated learning process.

The first node 111 may perform the selection of the one or more selected nodes 120 based on a comprehensive consideration of all the above information.

The selecting in this Action 704 may be performed, for example, before starting the next round of learning/training of the ongoing distributed machine-learning or federated learning process.

The ongoing distributed machine-learning or federated learning process may then be continued using the one or more selected nodes 120.

An output of the ongoing distributed machine-learning or federated learning process may then be based on the ongoing distributed machine-learning or federated learning process, continued using the one or more selected nodes 120.

That the output of the ongoing distributed machine-learning or federated learning process may be based on the obtained one or more first indications may accordingly comprise that the first node 111 may perform the selecting of this Action 704 based on the one or more first indications. The first node 111 may then, as will be described later, continue, or terminate the ongoing distributed machine-learning or federated learning process using the one or more selected nodes 120, and the resulting output may thereby be based on the one or more first indications.

The first group of second nodes 112 may be used as a first group of clients and the one or more selected nodes 120 may be selected to be used as a second group of clients to continue the ongoing distributed machine-learning or federated learning process.

This Action 704 may be performed during the ongoing distributed machine-learning or federated learning process.

By selecting the one or more selected nodes 120 from the first group of second nodes 112 and the one or more third nodes 113, the first node 111 may thereby be enabled to expedite the training of the ongoing distributed machine-learning or federated learning process and/or to increase the accuracy of any resulting machine-learning model and/or to avoid that the learning/training may terminate due to stragglers, for the reasons explained earlier.

### Action 705

In this Action 705, the first node 111 may determine, based on, that is, considering or using, the obtained respective information for the one or more selected nodes 120, at least one of the following. According to a first option, the first node 111 may determine a time needed to complete a service to a consumer of the ongoing distributed machine-learning or federated learning process using the one or more selected nodes 120. The first node 111 may estimate the time for completing training if model provision is required. According to a first option, the first node 111 may determine a level of accuracy for providing the service to the consumer using the one or more selected nodes 120. The first node 111 may estimate the time for completing training and inference if analytic results, e.g., statistics or predictions, are required.

Determining may be understood as calculating, estimating, deriving, or obtaining from another node.

This Action 705 may be performed during the ongoing distributed machine-learning or federated learning process.

By in this Action 705 determining the time or the level of accuracy for providing the required service to the consumer with the current one or more selected nodes 120, e.g., Client NWDAF(s), the first node 111 be enabled to judge whether the requirement from the consumer, e.g., NWDAF service consumer, may be satisfied with the current one or more selected nodes 120, e.g., selected Client NWDAF(s), and whether to continue the ongoing distributed machine-learning or federated learning process with the current one or more selected nodes 120, e.g., selected Client NWDAF(s), or whether to terminate it.

### Action 706

In this Action 706, the first node 111 may determine, based on the obtained respective one or more first indications, whether the ongoing distributed machine-learning or federated learning process is to be continued with any of the one or more selected nodes 120. That the determining may be based on the obtained respective one or more first indications may be understood to mean that the willingness, capability, availability, etc., of the one or more third nodes 113 be taken into consideration when deciding whether or not the ongoing distributed machine-learning or federated learning process is to be continued with any of the one or more selected nodes 120.

The determining in this Action 706 may be further based on the time and/or the level of accuracy for providing the service.

That the output of the ongoing distributed machine-learning or federated learning process may be based on the obtained one or more first indications may accordingly comprise that the first node 111 may perform the determining of this Action 706. The first node 111 may then, as will be described later, continue, or terminate the ongoing distributed machine-learning or federated learning process using the one or more selected nodes 120, and the resulting output may thereby be based on the one or more first indications and/or the level of accuracy for providing the service.

If the first node 111 determines to continue the ongoing distributed machine-learning or federated learning process, the first node 11 may repeat any of Actions 702-706 until the service required by the consumer may be satisfied or the training process may be otherwise terminated.

This Action 706 may be performed during the ongoing distributed machine-learning or federated learning process.

By determining whether the ongoing distributed machine-learning or federated learning process is to be continued with any of the one or more selected nodes 120 in this Action 706, the first node 111 may be enabled to know whether or not to terminate the procedure to avoid unnecessary resource usage and time consumption.

### Action 707

In this Action 707, the first node 111 may send a respective second indication to the one or more selected nodes 120. The respective second indication may indicate to the one or more selected nodes 120 that they have been selected to continue the ongoing distributed machine-learning or federated learning.

The sending, in this Action 707 may be performed e.g., via the respective fourth link 154.

This Action 707 may be performed during the ongoing distributed machine-learning or federated learning process.

By sending the respective second indication to the one or more selected nodes 120 in this Action 707, the first node 111 may enable the one or more third nodes 113 know they may initiate data collection and local training of a corresponding machine-learning model for the ongoing distributed machine-learning or federated learning process.

### Action 708

In this Action 708, the first node 111 may update a machine-learning model resulting from the ongoing distributed machine-learning or federated learning process using third information provided by the one or more selected nodes 120.

The first node 111 may then send the updated machine-learning model, or one or more parameters, e.g., weights associated with it, to the one or more selected nodes 120. In other words, the first node 111 may distribute the updated, aggregated machine-learning model.

The first node 111 may similarly update the first information indicating the ongoing distributed machine-learning or federated learning process and provide the updated first information to the fifth node 115.

By updating the machine-learning model in this Action 708, the first node 111 may be enabled to, as explained above, expedite the training of the ongoing distributed machine-learning or federated learning process and/or to increase the accuracy of any resulting machine-learning model.

### Action 709

In this Action 709, the first node 111 provides, to the fourth node 114 operating in the communications system 100, an output of the ongoing distributed machine-learning or federated learning process based on the obtained one or more first indications.

The providing, e.g., sending, in this Action 709 may be performed e.g., via the fifth link 154.

The provided output may be based on the updated machine-learning model in Action 708. That is, the provided output may be that of executing the updated machine-learning model.

In some embodiments, wherein Action 704 may have been performed, the output of the ongoing distributed machine-learning or federated learning process may be based on the ongoing distributed machine-learning or federated learning process, continued using the one or more selected nodes 120.

In some of the embodiments wherein the first node 111 may have performed Action 705, the provided output may be based on a result on the determined time and/or level of accuracy. That is, the ongoing distributed machine-learning or federated learning process which may have resulted in the machine-learning model whose output may be provided may have been continued, updated, or terminated considering the determined time and/or level of accuracy.

In some of the embodiments wherein the first node 111 may have performed Action 706, the output may be based on a result of the determination performed in Action 706. That is, the output may be that of an updated machine-learning model if the first node 111 may have decided to continue the process, and of the current ongoing distributed machine-learning or federated learning process is to be continued, terminated, if so may have been decided by the first node 111.

In other words, there may be two types of termination which may correspond to two types of output, desired and undesired output. For a desired termination, the training may be understood to be finished, and in this case, the output may be the final result of the process, e.g., trained model and/or analytics. For an undesired termination, based on the time and/or accuracy judged in Action 705, and the determination made in Action 706, the output may be e.g., a terminate indication with or without an intermediate result. Both may be possible.

By providing the output of the ongoing distributed machine-learning or federated learning process to the fourth node 114 in this Action 709, the first node 111 may enable the fourth node 114 to obtain the machine-learning model, or its parameters, in an expedited fashion and/or with increased accuracy, since the first node 111 may have been able to dynamically add or reselect the group of clients to aggregate data and/or analytics from in order to perform the training. This may apply in embodiments wherein the training phase with the first node 111 may have finished. The training may be finished if a specified number of iterations or a result of loss function lower than a threshold may have been reached. If this is not the case, by providing the output, the first node 111 may enable the fourth node 114 to avoid wasting time waiting for services that cannot meet certain requirements it may have requested. The fourth node 114 may then be enabled to select a new first node 111 and/or additional one or more third nodes 113 in time to provide the required services.

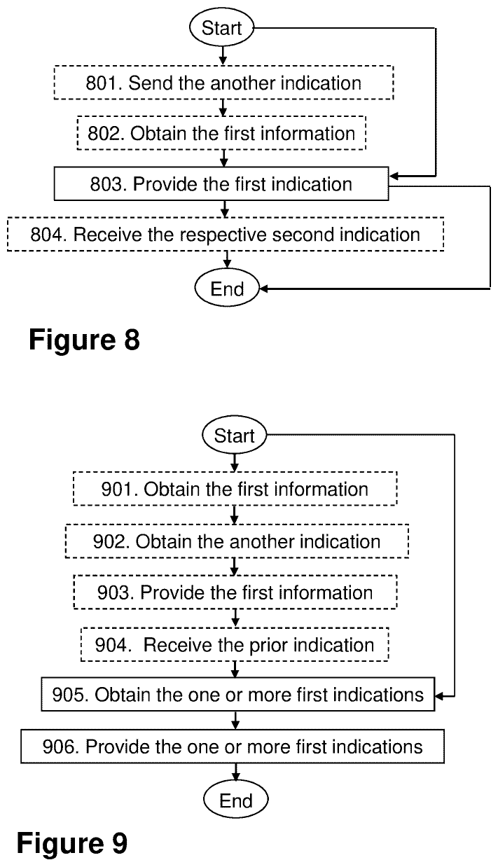

Embodiments of a computer-implemented method performed by the third node 113, will now be described with reference to the flowchart depicted in FIG. 8. The method may be understood to be for handling the ongoing distributed machine-learning or federated learning process. The third node 113 operates in the communications system 100.

The method may comprise the following actions. Several embodiments are comprised herein. In some embodiments, the method may comprise all actions. In other embodiments, the method may comprise one or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 8, optional actions are depicted with dashed lines.

The detailed description of some of the following corresponds to the same references provided above, in relation to the actions described for the first node 111 and will thus not be repeated here to simplify the description. For example, in some embodiments wherein the communications system 100 may be a 5G network, the first node 111 may be a server NWDAF, the first group of second nodes 112 may be client NWDAFs, the one or more third nodes 113 may be other client NWDAFs, that is the third node 113 may be another client NWDAF, the fourth node 114 may be a NWDAF service consumer, and the fifth node 115 may be a DLCF.

### Action 801

In this Action 801, the third node 113 may send another indication to the fifth node 115.

The another indication may request the first information. That is, the first information indicating the ongoing distributed machine-learning or federated learning process.

The sending in this Action 801 may be performed e.g., via the respective third link 153.

This Action 801 may be performed in examples wherein the third node 113 may not have, or may not have obtained, the information about the first node 111, e.g., according to preconfigured information from Operations, Administration and Maintenance (OAM), or from its previous processing of the same or other tasks related to the first node 111.

The one or more actions may comprise at least one of: administering the group of devices 130, configuring the group of devices 130 and monitoring events of the group of devices 130.

This Action 801 may be performed during the ongoing distributed machine-learning or federated learning process.

The another indication may be a query to the fifth node 115 for discovering the first node 111. The another indication may comprise the identifier of the ongoing distributed machine-learning or federated learning process, e.g., the DML/FL Correlation ID, and/or the Analytics ID.

### Action 802

In this Action 802, the third node 113 may obtain, from at least one of the fifth node 115 and a memory storage, e.g., a first memory storage, the first information. The first information may indicate the ongoing distributed machine-learning or federated learning process. The first information may indicate the identifier of the ongoing distributed machine-learning or federated learning process.

The obtaining, e.g., retrieving or receiving, in this Action 802 may be performed e.g., via the respective third link 153.

The obtaining in this Action 802 of the first information may be based on, e.g., in response to, the sent another indication.

This Action 802 may be performed during the ongoing distributed machine-learning or federated learning process.

### Action 803

In this Action 803, the third node 113 provides the first indication about the third node 113 to one of the first node 111 and the fifth node 115 operating in the communications system 100. As explained earlier, the first node 111 acts the aggregator of data or analytics from the first group of second nodes 112 in the ongoing distributed machine-learning or federated learning process. The first indication comprises respective information about the third node 113. The respective information indicates that the third node 113 is eligible to be selected to participate in the ongoing distributed machine-learning or federated learning process.

The first indication is provided during the ongoing distributed machine-learning or federated learning process, that is, dynamically.

The respective information may indicate, e.g., with respect to performing the one or more training tasks of the ongoing distributed machine-learning or federated learning process, one or more of the following options. According to the first option, the respective information may indicate the respective willingness to join the ongoing distributed machine-learning or federated learning process, which may be identified for example with the DML/FL Correlation ID, and/or the Analytics ID. According to the second option, the respective information may indicate the respective first capability to complete one or more training tasks of the ongoing distributed machine-learning or federated learning process, e.g., available computation resource, achievable speed/required time for completing tasks, etc. According to the third option, the respective information may indicate one or more respective characteristics of available data to the third node 113, e.g., area of interest, stored previous analytics and/or training data and results, etc. According to the fourth option, the respective information may indicate the respective supported machine-learning framework, e.g., DML/FL, etc. According to the fifth option, the respective information may indicate the respective time availability to participate in the ongoing distributed machine-learning or federated learning process. That is, available time for participating in the next rounds of training, e.g., available time duration, etc. The third node 113 may only be available to participate in partial rounds of the rest of the training.

The providing, e.g., sending, in this Action 803 may be performed one of: by sending the first indication directly to the first node 111, and by sending the first indication to the fifth node 115 the third node 113 may have previously registered with. The third node 113 may send the first indication directly to the first node 111 if the third node 113 already may have, or may have obtained, the information about the first node 111 according to preconfigured information from OAM, or from its previous processing of the same or other tasks related to the first node 111, or through discovery from the fifth node 115.

In some embodiments, the providing in this Action 803 of the first indication may comprise registering the respective information with the fifth node 115.

The providing in this Action 803 of the first indication may be based on the obtained first information. That is, the third node 113 may provide the first indication after learning about the ongoing distributed machine-learning or federated learning process. The first information may indicate the identifier of the ongoing distributed machine-learning or federated learning process.

### Action 804

After providing the first indication, the third node 113 may be selected from the first group of second nodes 112 and one or more third nodes 113 comprising the third node 113, based on, that is taking into consideration, the provided first indication, to be comprised in the one or more selected nodes 120 to continue the ongoing distributed machine-learning or federated learning process.

The first group of second nodes 112 may be used as a first group of clients and the third node 113 may be selected to be used as part of a second group of clients to continue the ongoing distributed machine-learning or federated learning process.

In some of such embodiments, in this Action 804, the third node 113 may receive a respective second indication from the first node 111. The respective second indication may indicate the third node 113 has been selected to continue the ongoing distributed machine-learning or federated learning.

The receiving in this Action 804 may be performed e.g., via the respective fourth link 154.

In some embodiments, the providing in Action 803 of the first indication may comprise registering the respective information with the fifth node 115, and the receiving in this Action 804 of the respective second indication may be based on the registered respective information. That is, the third node 113 may have been selected based on the respective information registered with the fifth node 115, which the first node 111 may have obtained.

The ongoing distributed machine-learning or federated learning process may then be continued using the one or more selected nodes 120, and the output of the ongoing distributed machine-learning or federated learning process may be based on, that is, may be a result of, the ongoing distributed machine-learning or federated learning process, continued using the one or more selected nodes 120.

This Action 804 may be performed during the ongoing distributed machine-learning or federated learning process.

Embodiments of a computer-implemented method performed by the fifth node 115, will now be described with reference to the flowchart depicted in FIG. 9. The method may be understood to be for handling the ongoing distributed machine-learning or federated learning process. The fifth node 115 operates in the communications system 100.

The method comprises the following actions. In some embodiments, the method may comprise all actions. In other embodiments, the method may comprise two or more actions. Several embodiments are comprised herein. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first node 111 and will thus not be repeated here to simplify the description. For example, in some embodiments wherein the communications system 100 may be a 5G network, the first node 111 may be a server NWDAF, the first group of second nodes 112 may be client NWDAFs, the one or more third nodes 113 may be other client NWDAFs, and the fifth node 115 may be a DLCF.

### Action 901

In this Action 901, the fifth node 115 may obtain, from the first node 111 and a memory storage, e.g., the first memory storage or a second memory storage, the first information indicating the ongoing distributed machine-learning or federated learning process. The first information may indicate at least one of: a) the identifier of the ongoing distributed machine-learning or federated learning process, and b) the second information about the first group of second nodes 112 used for the ongoing distributed machine-learning or federated learning process.

The obtaining, e.g., retrieving or receiving, in this Action 901 may be performed, e.g., via the second link 152.

This Action 901 may be performed during the ongoing distributed machine-learning or federated learning process.

### Action 902

In this Action 902, the fifth node 115 may obtain the another indication from the one or more third nodes 113. The another indication may request the first information.

This Action 902 may be performed during the ongoing distributed machine-learning or federated learning process.

### Action 903

In this Action 903, the fifth node 115 may provide the first information to the one or more third nodes 113, based on the obtained another indication.

The providing, e.g., sending, in this Action 903 may be performed, e.g., via the respective third link 153.

This Action 903 may be performed during the ongoing distributed machine-learning or federated learning process.

### Action 904

In this Action 904, the fifth node 115 may receive the prior indication from the first node 111. The prior indication may request the one or more first indications.

The receiving in this Action 903 may be performed, e.g., via the second link 152.

This Action 904 may be performed during the ongoing distributed machine-learning or federated learning process.

### Action 905

The fifth node 115 obtains the one or more first indications from the one or more third nodes 113 operating in the communications system 100. The one or more first indications comprise the respective information indicating that the one or more third nodes 113 are eligible to be selected to participate in the ongoing distributed machine-learning or federated learning process. The one or more first indications are obtained during the ongoing distributed machine-learning or federated learning process.

The obtaining, e.g., receiving, in this Action 905 may be performed, e.g., via the respective third link 153.

The obtaining in this Action 905 of the one or more first indications may be based on the registered first information. That is, the obtaining of the one or more first indications may be based on the ongoing distributed machine-learning or federated learning process having been identified with the identifier and registered with the fifth node 115.

In some embodiments, the obtaining in this Action 905 of the one or more first indications may comprise registering the respective information from the one or more third nodes 113.

### Action 906

The fifth node 115 provides the one or more first indications to the first node 111 operating in the communications system 100. The first node 111, as stated earlier, acts the aggregator of data or analytics from the first group of second nodes 112 for the ongoing distributed machine-learning or federated learning process. The one or more first indications are provided during the ongoing distributed machine-learning or federated learning process.

The respective information may indicate, e.g., with respect to performing the one or more training tasks of the ongoing distributed machine-learning or federated learning process, one or more of the following options. According to the first option, the respective information may indicate the respective willingness to join the ongoing distributed machine-learning or federated learning process, which may be identified for example with the DML/FL Correlation ID, and/or the Analytics ID. According to the second option, the respective information may indicate the respective first capability to complete one or more training tasks of the ongoing distributed machine-learning or federated learning process, e.g., available computation resource, achievable speed/required time for completing tasks, etc. According to the third option, the respective information may indicate the one or more respective characteristics of available data to the respective third node 113, e.g., area of interest, stored previous analytics and/or training data and results, etc. According to the fourth option, the respective information may indicate the respective supported machine-learning framework, e.g., DML/FL, etc. According to the fifth option, the respective information may indicate the respective time availability to participate in the ongoing distributed machine-learning or federated learning process. That is, available time for participating in the next rounds of training, e.g., available time duration, etc. Some of the one or more third nodes 113 may only be available to participate in partial rounds of the rest of the training.

In some embodiments, the obtaining in Action 905 of the one or more first indications may comprise registering the respective information from the one or more third nodes 113. The providing in this Action 906 of the one or more first indications may be based on the registered respective information. That is, the fifth node 115 may itself only provide the one or more first indications of the one or more third nodes 113 that, considering the registered respective information, may be most suitable to continue the ongoing distributed machine-learning or federated learning process, e.g., that may match any requirements the first node 111 may have indicated in the prior indication, or characteristics indicated in the first information.

Two non-limiting example of a method in the communications system 100 according to embodiments herein will now be described in the next Figure.

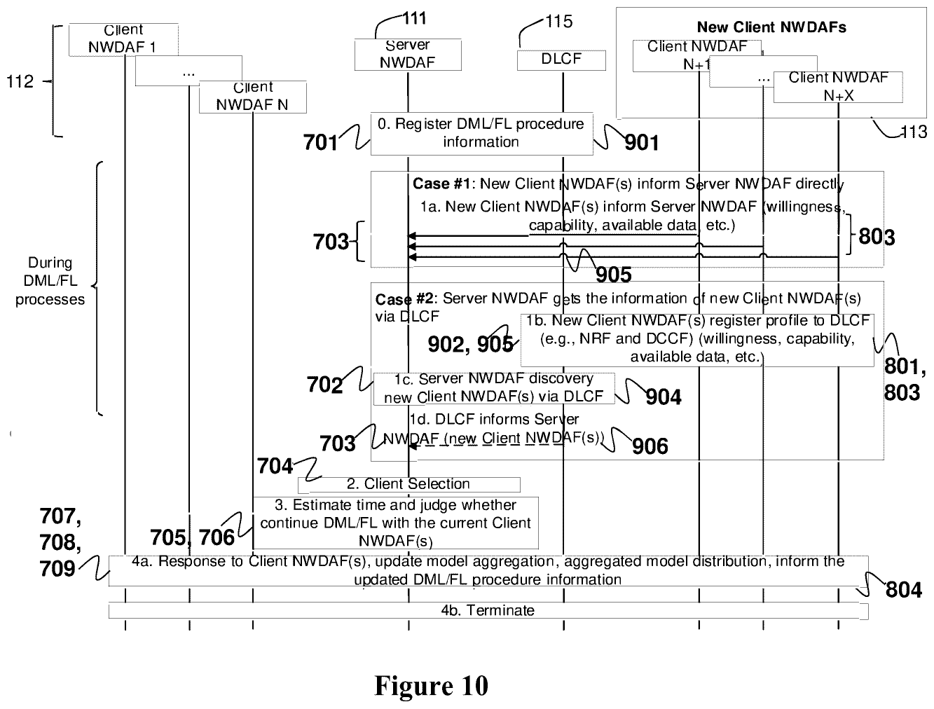

FIG. 10 is a signalling diagram depicting two non-limiting examples of a method performed in the communications system 100, according to embodiments herein. In the non-limiting examples depicted FIG. 10, the first node 111 is a Server NWDAF, the first group of second nodes 112 comprises client NWDAFs, the one or more third nodes 113 are new client NWDAFs, and the fifth node 115 is an DLCF, e.g., NRF, DCCF, etc. FIG. 10 illustrates the procedure for dynamic addition of new client NWDAF(s) to DML/FL processes described in relation to FIGS. 7-9, in 5GC. The first group of second nodes 112, in FIG. 10 client NWDAFs 1 to N have been selected by the first node 111 for participating the current round of DML/FL. The one or more third nodes 113, in FIG. 10, client NWDAFs N+1 to N+X, which are the new ones, have the willingness and/or capability to join in the next rounds of training processes. There may be two possible cases for the first node 111 to get the information of the new client NWDAF(s). That is, from the new Client NWDAF(s) directly or via the fifth node 115, that is the DLCF. In a first group of embodiments, referred to in FIG. 10 as Case #1, the one or more third nodes 113 may inform the first node 111 directly. In Case #1, the one or more third nodes 113 which may be willing to and/or may have the capability to join in the DML/FL processes, may know the information about the first node 111, and may inform the first node 111 directly. The corresponding procedure for dynamic addition of new Client NWDAF(s) to DML/FL may be, in such case: At step 0, the first node 111 may register, according to Action 701 and Action 901, with the fifth node 115 about the DML/FL procedure with the following parameters: DML/FL Correlation ID, Analytics ID and Client NWDAF(s) information. At Step 1, according to option 1a, if the information about the first node 111 is known, the one or more third nodes 113, that is, the new client NWDAF(s) may, according to Action 803, inform the first node 111 about their willingness to join the DML/FL process during the DML/FL training processes. The willingness message may include the following parameters: DML/FL Correlation ID, Analytics ID, Capability, Available data, Supported ML framework, and Available time for participate in the training, etc. The one or more third nodes 113 may already have, or may obtain, the information about the first node 111 according to preconfigure information from OAM, or from its previous processing of the same or other tasks related to the first node 111. Alternatively, the one or more third nodes 113 may send, according to Action 801, the query to the fifth node 115 for discovering the first node 111. The query may include the following parameters: DML/FL Correlation ID, and Analytics ID. At Step 2, before starting the next round of learning/training, the first node 111 may, according to Action 704, select the one or more selected nodes 120, from NWDAFs 1 to N+X, based on the following updated information of the Client NWDAF(s): a) indication of willingness to join in the DML/FL training process, b) capability for completing training tasks, e.g., available computation resource, achievable speed/required time for completing tasks, etc., c) available data, e.g., area of interest, stored previous analytics and/or training data and results, etc., d) supported ML framework, e.g., DML/FL, etc., and e) available time for participate in the next rounds of training, e.g., available time duration, etc. Some of the one or more selected nodes 120 may only be available to participate in partial rounds of the rest training. The first node 111 may perform Client NWDAF(s) selection based on a comprehensive consideration of all the above information. At Step 3, the first node 111 may estimate, according to Action 705, the time and accuracy level for providing the required service to consumer with the current one or more selected nodes 120, and, according to Action 706, may judge whether to continue the DML/FL. If model provision is required by the fourth node 114, the time for completing training may be estimated. If the analytic results, e.g., statistics or predictions, are required, the time for completing the training and inference may be estimated. Next, at Step 4a, if the first node 111 has decided to continue, as judged in Step 3, the first node 111 may send, according to Action 707, responses to the one or more selected nodes 120, may, according to Action 708, update model aggregation, and perform aggregated model distribution, e.g., the first node 111 may forward, such as model information metadata, weights, etc. to the one or more selected nodes 120, and may inform the fifth node 115 about the updated DML/FL procedure information. At Step 4b, if the first node 111 has determined to not continue, as judged in Step 3, the first node 111 may terminate the training process. If the first node 111 determines not to terminate the process, the steps 1-4, 4a, may be repeated until the service required by the consumer may be satisfied, or the training process may be terminated in Step 4b.

In a second group of embodiments, referred to in FIG. 10 as Case #2, the first node 111 may get the information about the one or more third nodes 113 via the fifth node 115. In Case #2, the one or more third nodes 113, that is, new Client NWDAF(s), which may be willing to and/or may have the capability to join in the DML/FL processes, do not know the information about the first node 111. The first node 111 may get the information of the one or more third nodes 113 dynamically via the fifth node 115. The corresponding procedure for dynamic addition of new Client NWDAF(s) to DML/FL may be as follows. The step 0 for Case #2 is the same as that for Case #1. At Step 1b, the one or more third nodes 113 may, according to Action 801 and Action 803, register their respective profile into the fifth node 115, e.g., NRF and/or DCCF, etc., together with their willingness to join the DML/FL process during the DML/FL training processes. The willingness message may include the following parameters: DML/FL Correlation ID, Analytics ID, Capability, Available data, Supported ML framework, and Available time for participate in the training, etc. The first node 111 may get the information about the one or more third nodes 113 from the fifth node 115 in Step 1c or 1d. In Step 1c, the obtaining may be performed via Request-Response. The first node 111 may send, according to Action 702, a discovery request to the first node 111, e.g., NRF. The fifth node 115 may then respond to the first node 111 with the information about the one or more third nodes 113, according to Action 906. At Step 1d, alternately, the obtaining may be performed via Subscribe-Notify. The first node 111 may subscribe to the fifth node 115, e.g., DCCF. The fifth node 115 may then push the information about the one or more third nodes 113 to the first node 111. The one or more third nodes 113 may register their profile into the fifth node 115, e.g., NRF and/or DCCF, etc., dynamically during the DML/FL processes. The first node 111 may discover the information about the one or more third nodes 113 from the fifth node 115 as described in Step 1c. Or the fifth node 115 may push the information about the one or more third nodes 113 to the first node 111 dynamically as described in Step 1d. The steps 2-4 for Case #2 may be understood to be the same as that for Case #1.

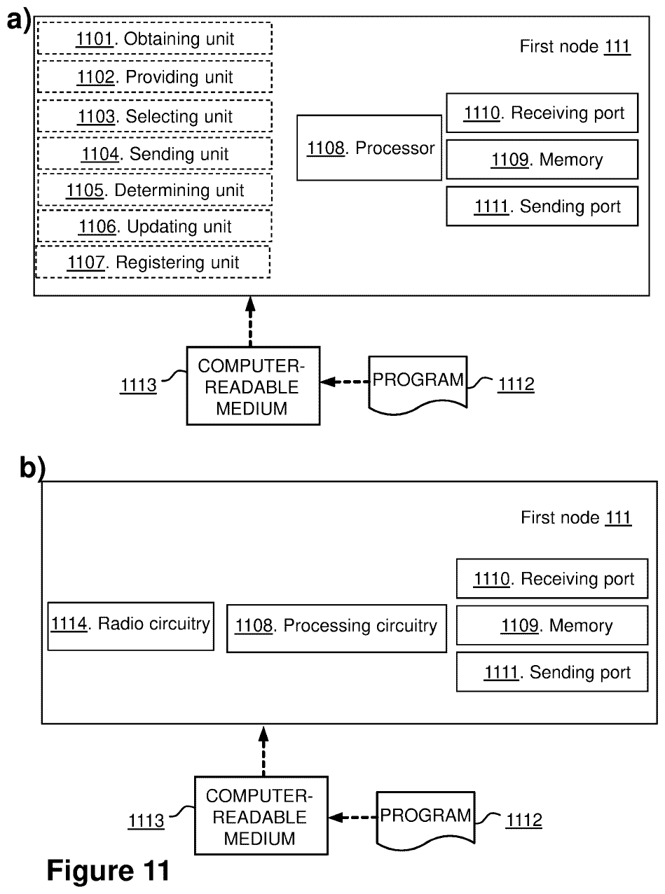

FIG. 11 depicts two different examples in panels a) and b), respectively, of the arrangement that the first node 111 may comprise to perform the method actions described above in relation to FIG. 7 and/or FIG. 10. In some embodiments, the first node 111 may comprise the following arrangement depicted in FIG. 11a. The first node 111 may be understood to be for handling the distributed machine-learning or federated learning process configured to be ongoing, for which the first node 111 is configured to act the aggregator of data or analytics from the first group of second nodes 112. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 11, optional boxes are indicated by dashed lines. The detailed description of some of the following corresponds to the same references provided above, in relation to the actions described for the first node 111 and will thus not be repeated here. For example, the communications system 100 may be configured to be a 5G network, and: a) the first node 111 may be configured to be a server NWDAF, b) the first group of second nodes 112 may be configured to be client NWDAFs, c) the one or more third nodes 113 may be configured to be other client NWDAFs, d) the fourth node 114 may be configured to be a NWDAF service consumer, and e) the fifth node 115 may be configured to be a DLCF.

The first node 111 is configured to, e.g., by means of an obtaining unit 1101 within the first node 111 configured to, obtain the one or more first indications about the one or more third nodes 113 configured to operate in the communications system 100. The one or more first indications are configured to comprise respective information about the one or more third nodes 113. The respective information is configured to indicate that the one or more third nodes 113 are eligible to be selected to participate in the distributed machine-learning or federated learning process configured to be ongoing. The one or more first indications are configured to be obtained during the distributed machine-learning or federated learning process configured to be ongoing.

The first node 111 is also configured to, e.g., by means of a providing unit 1102 within the first node 111 configured to, provide, to the fourth node 114 configured to operate in the communications system 100, the output of the distributed machine-learning or federated learning process configured to be ongoing, based on the one or more first indications configured to be obtained.

In some embodiments, the first node 111 may be also configured to, e.g., by means of a selecting unit 1103 within the first node 111 configured to, select, based on the respective one or more first indications configured to be received, from the first group of second nodes 112 and the one or more third nodes 113, the one or more selected nodes 120 to continue the distributed machine-learning or federated learning process configured to be ongoing. The distributed machine-learning or federated learning process configured to be ongoing may be configured to be continued using the one or more selected nodes 120. The output may be configured to be based on the distributed machine-learning or federated learning process configured to be ongoing, continued using the one or more selected nodes 120.

In some embodiments, that the output may be configured to be based on the one or more first indications configured to be obtained may be configured to comprise that, the first node 111 may be also configured to, e.g., by means of the selecting unit 1103 within the first node 111 configured to, select, based on the respective one or more first indications configured to be received, from the first group of second nodes 112 and the one or more third nodes 113, the one or more selected nodes 120 to continue the distributed machine-learning or federated learning process configured to be ongoing. The distributed machine-learning or federated learning process configured to be ongoing may be configured to be continued using the one or more selected nodes 120. The output may be configured to be based on the distributed machine-learning or federated learning process configured to be ongoing, continued using the one or more selected nodes 120.

In some embodiments, the first node 111 may be also configured to, e.g., by means of a sending unit 1104 within the first node 111 configured to, send the respective second indication to the one or more selected nodes 120. The respective second indication may be configured to indicate to the one or more selected nodes 120 that they have been selected to continue the distributed machine-learning or federated learning configured to be ongoing.

In some embodiments, that the output may be configured to be based on the one or more first indications configured to be obtained may be configured to comprise that, the first node 111 may be also configured to, e.g., by means of the sending unit 1104 within the first node 111 configured to, send the respective second indication to the one or more selected nodes 120. The respective second indication may be configured to indicate to the one or more selected nodes 120 that they have been selected to continue the distributed machine-learning or federated learning configured to be ongoing.

In some embodiments, the first node 111 may be also configured to, e.g., by means of a determining unit 1105 within the first node 111 configured to, determine, based on the respective one or more first indications configured to be obtained, whether the distributed machine-learning or federated learning process configured to be ongoing is to be continued with any of the one or more selected nodes 120. The output may be configured to be based on the result of the determination.

In some embodiments, that the output may be configured to be based on the one or more first indications configured to be obtained may be configured to comprise that, the first node 111 may be also configured to, e.g., by means of the determining unit 1105 within the first node 111 configured to, determine, based on the respective one or more first indications configured be to obtained, whether the distributed machine-learning or federated learning process configured to be ongoing is to be continued with any of the one or more selected nodes 120. The output may be configured to be based on the result of the determination.

In some embodiments, the first group of second nodes 112 may be configured to be used as the first group of clients and the one or more selected nodes 120 may be configured to be selected to be used as the second group of clients to continue the distributed machine-learning or federated learning process configured to be ongoing.

In some embodiments, the first node 111 may be also configured to, e.g., by means of an updating unit 1106 within the first node 111 configured to, update the machine-learning model configured to be resulting from the distributed machine-learning or federated learning process configured to be ongoing using the third information configured to be provided by the one or more selected nodes 120. The output configured to be provided may be configured to be based on the machine-learning model configured to be updated.

In some embodiments, the respective information configured to be comprised in the one or more first indications may be configured to indicate, one or more of: a) the respective willingness to join the distributed machine-learning or federated learning process configured to be ongoing, b) the respective first capability to complete one or more training tasks of the distributed machine-learning or federated learning process configured to be ongoing, c) the one or more respective characteristics of available data to a respective third node 113, d) the respective supported machine-learning framework, and e) the respective time availability to participate in the distributed machine-learning or federated learning process configured to be ongoing.

In some embodiments, the first node 111 may be also configured to, e.g., by means of the determining unit 1105 within the first node 111 configured to, determine, based on the respective information for the one or more selected nodes 120 configured to be obtained, at least one of: a) the time needed to complete the service to the consumer of the distributed machine-learning or federated learning process configured to be ongoing using the one or more selected nodes 120, and b) the level of accuracy for providing the service to the consumer using the one or more selected nodes 120. The output configured to be provided may be configured to be based on the result on the time and/or level of accuracy configured to be determined.

In some embodiments, the obtaining may be configured to be performed one of: a) directly from, respectively, the one or more third nodes 113, and b) via the fifth node 115 configured to operate in the communications system 100 the one or more third nodes 113 may be configured to have previously registered with.

In some embodiments, the first node 111 may be also configured to, e.g., by means of a registering unit 1107 within the first node 111 configured to, register with the fifth node 115 the first information configured to indicate the distributed machine-learning or federated learning process configured to be ongoing. The first information may be configured to indicate at least one of: a) the identifier of the distributed machine-learning or federated learning process configured to be ongoing, and b) the second information about the first group of second nodes 112 configured to be used for the distributed machine-learning or federated learning process configured to be ongoing. The obtaining of the one or more first indications may be configured to be based on the first information configured to be registered.

In some embodiments, the first node 111 may be also configured to, e.g., by means of the sending unit 1104 within the first node 111 configured to, send the prior indication to the fifth node 115. The prior indication may be configured to request the one or more first indications. The obtaining of the one or more first indications may be configured to be based on the prior indication configured to be sent.

The embodiments herein may be implemented through one or more processors, such as a processor 1108 in the first node 111 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1109 comprising one or more memory units. The memory 1109 is arranged to be used to store obtained information, store data, configurations, schedulings, and applications etc. to perform the methods herein when being executed in the first node 111.

In some embodiments, the first node 111 may receive information from, e.g., the first group of second nodes 112, the one or more third nodes 113, the fourth node 114, the fifth node 115, the first plurality of radio networks nodes 141, the second plurality of radio networks nodes 142, the first plurality of devices 131, the second plurality of devices 132 and/or another node or device through a receiving port 1110. In some examples, the receiving port 1110 may be, for example, connected to one or more antennas in the first node 111. In other embodiments, the first node 111 may receive information from another structure in the communications system 100 through the receiving port 1110. Since the receiving port 1110 may be in communication with the processor 1108, the receiving port 1110 may then send the received information to the processor 1108. The receiving port 1110 may also be configured to receive other information.

The processor 1108 in the first node 111 may be further configured to transmit or send information to e.g., the first group of second nodes 112, the one or more third nodes 113, the fourth node 114, the fifth node 115, the first plurality of radio networks nodes 141, the second plurality of radio networks nodes 142, the first plurality of devices 131, the second plurality of devices 132, another node or device and/or another structure in the communications system 100, through a sending port 1111, which may be in communication with the processor 1108, and the memory 1109.

Those skilled in the art will also appreciate that any of the units 1101-1107 described above may refer to a combination of analog and digital circuits, and/or one or more processors configured with software and/or firmware, e.g., stored in memory, that, when executed by the one or more processors such as the processor 1108, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1101-1107 described above may be the processor 1108 of the first node 111, or an application running on such processor.

Thus, the methods according to the embodiments described herein for the first node 111 may be respectively implemented by means of a computer program 1112 product, comprising instructions, i.e., software code portions, which, when executed on at least one processor 1108, cause the at least one processor 1108 to carry out the actions described herein, as performed by the first node 111. The computer program 1112 product may be stored on a computer-readable storage medium 1113. The computer-readable storage medium 1113, having stored thereon the computer program 1112, may comprise instructions which, when executed on at least one processor 1108, cause the at least one processor 1108 to carry out the actions described herein, as performed by the first node 111. In some embodiments, the computer-readable storage medium 1113 may be a non-transitory computer-readable storage medium, such as a CD ROM disc, a memory stick, or stored in the cloud space. In other embodiments, the computer program 1112 product may be stored on a carrier containing the computer program, wherein the carrier is one of an electronic signal, optical signal, radio signal, or the computer-readable storage medium 1113, as described above.

The first node 111 may comprise an interface unit to facilitate communications between the first node 111 and other nodes or devices, e.g., the first group of second nodes 112, the one or more third nodes 113, the fourth node 114, the fifth node 115, the first plurality of radio networks nodes 141, the second plurality of radio networks nodes 142, the first plurality of devices 131, the second plurality of devices 132, another node or device and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 11b. The first node 111 may comprise a processing circuitry 1108, e.g., one or more processors such as the processor 1108, in the first node 111 and the memory 1109. The first node 111 may also comprise a radio circuitry 1114, which may comprise e.g., the receiving port 1110 and the sending port 1111. The processing circuitry 1108 may be configured to, or operable to, perform the method actions according to FIG. 7 and/or FIG. 10, in a similar manner as that described in relation to FIG. 11a. The radio circuitry 1114 may be configured to set up and maintain at least a wireless connection with the first group of second nodes 112, the one or more third nodes 113, the fourth node 114, the fifth node 115, the first plurality of radio networks nodes 141, the second plurality of radio networks nodes 142, the first plurality of devices 131, the second plurality of devices 132, another node or device and/or another structure in the communications system 100.

Hence, embodiments herein also relate to the first node 111 operative for handling the distributed machine-learning or federated learning process configured to be ongoing for which the first node 111 is configured to act the aggregator of data or analytics from the first group of second nodes 112, the first node 111 being operative to operate in the communications system 100. The first node 111 may comprise the processing circuitry 1108 and the memory 1109, said memory 1109 containing instructions executable by said processing circuitry 1108, whereby the first node 111 is further operative to perform the actions described herein in relation to the first node 111, e.g., in FIG. 7 and/or FIG. 10.

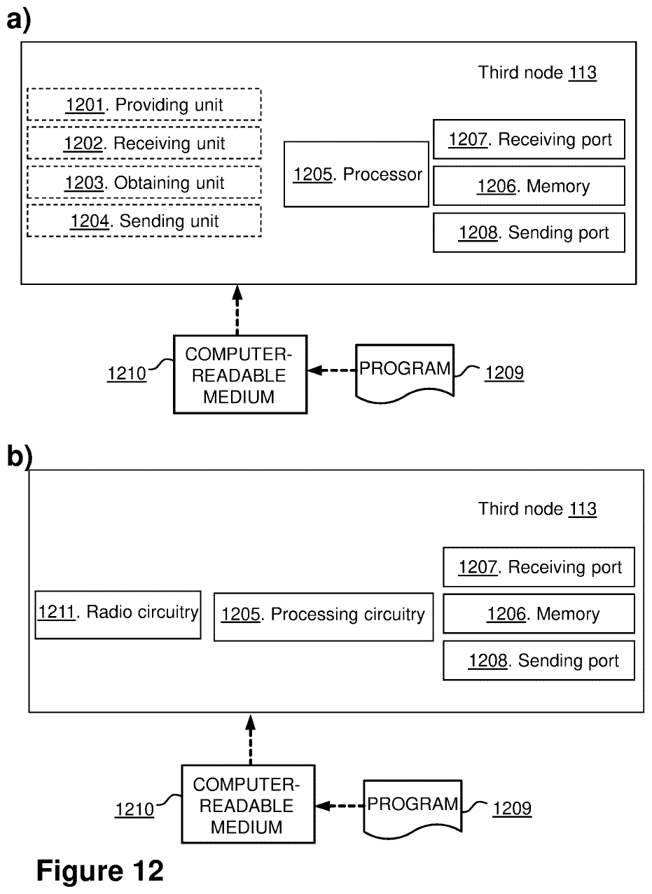

FIG. 12 depicts two different examples in panels a) and b), respectively, of the arrangement that the third node 113, may comprise to perform the method actions described above in relation to FIG. 8 and/or FIG. 10. In some embodiments, the third node 113 may comprise the following arrangement depicted in FIG. 12a. The third node 113 may be understood to be for handling the distributed machine-learning or federated learning process configured to be ongoing. The third node 113 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 12, optional boxes are indicated by dashed lines. The detailed description of some of the following corresponds to the same references provided above, in relation to the actions described for the third node 113 and will thus not be repeated here. For example, the communications system 100 may be configured to be a 5G network, and: a) the first node 111 may be configured to be a server NWDAF, b) the first group of second nodes 112 may be configured to be client NWDAFs, c) the one or more third nodes 113 may be configured to be other client NWDAFs, e.g., the third node 113 may be configured to be another client NWDAF, and d) the fifth node 115 may be configured to be a DLCF.

The third node 113 is configured to, e.g., by means of a providing unit 1201 within the third node 113 configured to, provide the first indication about the third node 113 to one of the first node 111 and the fifth node 115 configured to operate in the communications system 100. The first node 111 is configured to act as the aggregator of data or analytics from the first group of second nodes 112 in the distributed machine-learning or federated learning process configured to be ongoing. The first indication is configured to comprise the respective information about the third node 113. The respective information is configured to indicate that the third node 113 is eligible to be selected to participate in the distributed machine-learning or federated learning process configured to be ongoing. The first indication is configured to be provided during the distributed machine-learning or federated learning process configured to be ongoing.

In some embodiments wherein the third node 113 may be selected, from the first group of second nodes 112 and the one or more third nodes 113 configured to comprise the third node 113, based on the first indication configured to be provided, to be comprised in the one or more selected nodes 120 to continue the distributed machine-learning or federated learning process configured to be ongoing. In some of such embodiments, the third node 113 may be also configured to, e.g., by means of a receiving unit 1202 within the third node 113 configured to, receive the respective second indication from the first node 111. The respective second indication may be configured to indicate the third node 113 has been selected to continue the ongoing distributed machine-learning or federated learning.

In some embodiments, the distributed machine-learning or federated learning process configured to be ongoing may be continued using the one or more selected nodes 120, and the output of the distributed machine-learning or federated learning process configured to be ongoing may be configured to be based on the distributed machine-learning or federated learning process configured to be ongoing, continued using the one or more selected nodes 120.

In some embodiments, the first group of second nodes 112 may be configured to be used as the first group of clients and the third node 113 may be configured to be selected to be used as part of the second group of clients to continue the distributed machine-learning or federated learning process configured to be ongoing.

In some embodiments, the respective information may be configured to indicate, one or more of: a) the respective willingness to join the distributed machine-learning or federated learning process configured to be ongoing, b) the respective first capability to complete one or more training tasks of the distributed machine-learning or federated learning process configured to be ongoing, c) the one or more respective characteristics of available data to the third node 113, d) the respective supported machine-learning framework, and e) the respective time availability to participate in the distributed machine-learning or federated learning process configured to be ongoing.

In some embodiments, providing the first indication may be configured to comprise to register the respective information with the fifth node 115, and the receiving of the respective second indication may be configured to be based on the respective information configured to be registered.

In some embodiments, the providing may be configured to be performed one of: a) by sending the first indication directly to the first node 111, and b) by sending the first indication to the fifth node 115 the third node 113 may be configured to have previously registered with.

In some embodiments, the third node 113 may be further configured to, e.g., by means of an obtaining unit 1203 within the third node 113 configured to, obtain, from at least one of the fifth node 115 and the memory storage, e.g., the first memory storage, the first information being configured to indicate the distributed machine-learning or federated learning process configured to be ongoing. The first information may be configured to indicate the identifier of the distributed machine-learning or federated learning process configured to be ongoing, and the providing of the first indication may be configured to be based on the first information configured to be obtained.

In some embodiments, the third node 113 may be configured to, e.g., by means of a sending unit 1203 within the third node 113 configured to, send the another indication to the fifth node 115. The another indication may be further configured to request the first information. The obtaining of the first information may be configured to be based on the another indication configured to be sent.

The embodiments herein may be implemented through one or more processors, such as a processor 1205 in the third node 113 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the in the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1206 comprising one or more memory units. The memory 1206 is arranged to be used to store obtained information, store data, configurations, schedulings, and applications etc. to perform the methods herein when being executed in the third node 113.

In some embodiments, the third node 113 may receive information from, e.g., the first node 111, the first group of second nodes 112, the other one or more third nodes 113, the fourth node 114, the fifth node 115, the first plurality of radio networks nodes 141, the second plurality of radio networks nodes 142, the first plurality of devices 131, the second plurality of devices 132, and/or another node or device, through a receiving port 1207. In some examples, the receiving port 1207 may be, for example, connected to one or more antennas in the third node 113. In other embodiments, the third node 113 may receive information from another structure in the communications system 100 through the receiving port 1207. Since the receiving port 1207 may be in communication with the processor 1205, the receiving port 1207 may then send the received information to the processor 1205. The receiving port 1207 may also be configured to receive other information.

The processor 1205 in the third node 113 may be further configured to transmit or send information to e.g., the first node 111, the first group of second nodes 112, the other one or more third nodes 113, the fourth node 114, the fifth node 115, the first plurality of radio networks nodes 141, the second plurality of radio networks nodes 142, the first plurality of devices 131, the second plurality of devices 132, another node or device and/or another structure in the communications system 100, through a sending port 1208, which may be in communication with the processor 1205, and the memory 1206.

Those skilled in the art will also appreciate that any of the units 1201-1204 described above may refer to a combination of analog and digital circuits, and/or one or more processors configured with software and/or firmware, e.g., stored in memory, that, when executed by the one or more processors such as the processor 1205, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1201-1204 described above may be the processor 1205 of the third node 113, or an application running on such processor.

Thus, the methods according to the embodiments described herein for the third node 113 may be respectively implemented by means of a computer program 1209 product, comprising instructions, i.e., software code portions, which, when executed on at least one processor 1205, cause the at least one processor 1205 to carry out the actions described herein, as performed by the third node 113. The computer program 1209 product may be stored on a computer-readable storage medium 1210. The computer-readable storage medium 1210, having stored thereon the computer program 1209, may comprise instructions which, when executed on at least one processor 1205, cause the at least one processor 1205 to carry out the actions described herein, as performed by the third node 113. In some embodiments, the computer-readable storage medium 1210 may be a non-transitory computer-readable storage medium, such as a CD ROM disc, a memory stick, or stored in the cloud space. In other embodiments, the computer program 1209 product may be stored on a carrier containing the computer program, wherein the carrier is one of an electronic signal, optical signal, radio signal, or the computer-readable storage medium 1210, as described above.

The third node 113 may comprise an interface unit to facilitate communications between the third node 113 and other nodes or devices, e.g., the first node 111, the first group of second nodes 112, the other one or more third nodes 113, the fourth node 114, the fifth node 115, the first plurality of radio networks nodes 141, the second plurality of radio networks nodes 142, the first plurality of devices 131, the second plurality of devices 132, another node or device and/or another structure in the communications system 100. In some particular examples, the interface may, for example, include a transceiver configured to transmit and receive radio signals over an air interface in accordance with a suitable standard.

In other embodiments, the third node 113 may comprise the following arrangement depicted in FIG. 12b. The third node 113 may comprise a processing circuitry 1205, e.g., one or more processors such as the processor 1205, in the third node 113 and the memory 1206. The third node 113 may also comprise a radio circuitry 1211, which may comprise e.g., the receiving port 1207 and the sending port 1208. The processing circuitry 1205 may be configured to, or operable to, perform the method actions according to FIG. 8 and/or FIG. 10, in a similar manner as that described in relation to FIG. 12a. The radio circuitry 1211 may be configured to set up and maintain at least a wireless connection with the first node 111, the first group of second nodes 112, the other one or more third nodes 113, the fourth node 114, the fifth node 115, the first plurality of radio networks nodes 141, the second plurality of radio networks nodes 142, the first plurality of devices 131, the second plurality of devices 132, another node or device and/or another structure in the communications system 100.

Hence, embodiments herein also relate to the third node 113 operative for handling the distributed machine-learning or federated learning process configured to be ongoing, the third node 113 being operative to operate in the communications system 100. The third node 113 may comprise the processing circuitry 1205 and the memory 1206, said memory 1206 containing instructions executable by said processing circuitry 1205, whereby the third node 113 is further operative to perform the actions described herein in relation to the third node 113, e.g., in FIG. 8 and/or FIG. 10.

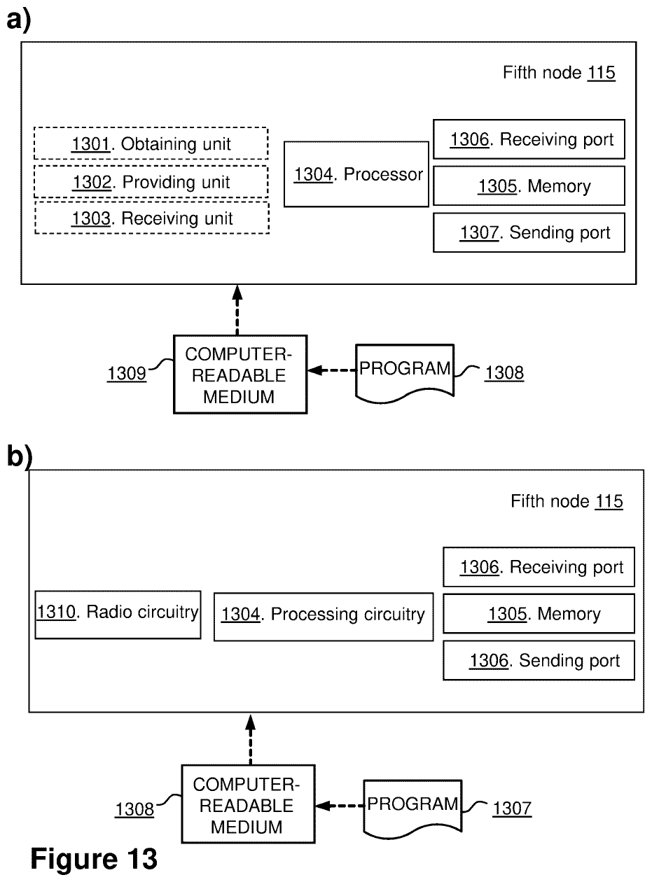

FIG. 13 depicts two different examples in panels a) and b), respectively, of the arrangement that the fifth node 115 may comprise to perform the method actions described above in relation to FIG. 9 and/or FIG. 10. In some embodiments, the fifth node 115 may comprise the following arrangement depicted in FIG. 13a. The fifth node 115 may be understood to be for handling the distributed machine-learning or federated learning process configured to be ongoing. The fifth node 115 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 13, optional boxes are indicated by dashed lines. The detailed description of some of the following corresponds to the same references provided above, in relation to the actions described for the fifth node 115 and will thus not be repeated here. For example, the communications system 100 may be configured to be a 5G network, and: a) the first node 111 may be configured to be a server NWDAF, b) the first group of second nodes 112 may be configured to be client NWDAFs, c) the one or more third nodes 113 may be configured to be other client NWDAFs, and d) the fifth node 115 may be configured to be a DLCF.

The fifth node 115 is configured to, e.g., by means of an obtaining unit 1301 within the fifth node 115 configured to, obtain the one or more first indications from the one or more third nodes 113 configured to operate in the communications system 100. The one or more first indications are configured to comprise the respective information configured to indicate that the one or more third nodes 113 are eligible to be selected to participate in the distributed machine-learning or federated learning process configured to be ongoing. The one or more first indications are configured to be obtained during the distributed machine-learning or federated learning process configured to be ongoing.

The fifth node 115 is also configured to, e.g., by means of a providing unit 1302 within the fifth node 115 configured to, provide the one or more first indications to the first node 111 configured to operate in the communications system 100. The first node 111 is configured to act as the aggregator of data or analytics from the first group of second nodes 112 for the distributed machine-learning or federated learning process configured to be ongoing. The one or more first indications are configured to be provided during the distributed machine-learning or federated learning process configured to be ongoing.

In some embodiments, the respective information may be configured to indicate, one or more of: a) the respective willingness to join the distributed machine-learning or federated learning process configured to be ongoing, b) the respective first capability to complete the one or more training tasks of the distributed machine-learning or federated learning process configured to be ongoing, c) the one or more respective characteristics of available data to the respective third node 113, d) the respective supported machine-learning framework, and e) the respective time availability to participate in the distributed machine-learning or federated learning process configured to be ongoing.

In some embodiments, obtaining the one or more first indications may be configured to comprise registering the respective information from the one or more third nodes 113, and the providing of the one or more first indications may be configured to be based on the respective information configured to be registered.

The fifth node 115 may be also configured to, e.g., by means of the obtaining unit 1301 within the fifth node 115 configured to, obtain, from one of the first node 111 and the memory storage, e.g., the first memory storage or the second memory storage, the first information configured to indicate the distributed machine-learning or federated learning process configured to be ongoing. The first information may be configured to indicate at least one of: a) the identifier of the distributed machine-learning or federated learning process configured to be ongoing, and b) the second information about the first group of second nodes 112 configured to be used for the distributed machine-learning or federated learning process configured to be ongoing. The obtaining of the one or more first indications may be configured to be based on the first information configured to be registered.

The fifth node 115 may be also configured to, e.g., by means of the obtaining unit 1301 within the fifth node 115 configured to, obtain the another indication from the one or more third nodes 113. The another indication may be configured to request the first information.

The fifth node 115 is also configured to, e.g., by means of the providing unit 1302 within the fifth node 115 configured to, provide the first information to the one or more third nodes 113, based on the another indication configured to be obtained.

The fifth node 115 is configured to, e.g., by means of a receiving unit 1303 within the fifth node 115 configured to, receive the prior indication from the first node 111. The prior indication may be configured to request the one or more first indications. The providing of the one or more first indications may be configured to be based on the prior indication configured to be received.

The embodiments herein may be implemented through one or more processors, such as a processor 1304 in the fifth node 115 depicted in FIG. 13, together with computer program code for performing the functions and actions of the embodiments herein. The program code mentioned above may also be provided as a computer program product, for instance in the form of a data carrier carrying computer program code for performing the embodiments herein when being loaded into the in the fifth node 115. One such carrier may be in the form of a CD ROM disc. It is however feasible with other data carriers such as a memory stick. The computer program code may furthermore be provided as pure program code on a server and downloaded to the fifth node 115.

The fifth node 115 may further comprise a memory 1305 comprising one or more memory units. The memory 1305 is arranged to be used to store obtained information, store data, configurations, schedulings, and applications etc. to perform the methods herein when being executed in the fifth node 115.

In some embodiments, the fifth node 115 may receive information from, e.g., the first node 111, the first group of second nodes 112, the other one or more third nodes 113, the fourth node 114, the fifth node 115, the first plurality of radio networks nodes 141, the second plurality of radio networks nodes 142, the first plurality of devices 131, the second plurality of devices 132 and/or another node or device, through a receiving port 1306. In some examples, the receiving port 1306 may be, for example, connected to one or more antennas in the fifth node 115. In other embodiments, the fifth node 115 may receive information from another structure in the communications system 100 through the receiving port 1306. Since the receiving port 1306 may be in communication with the processor 1304, the receiving port 1306 may then send the received information to the processor 1304. The receiving port 1306 may also be configured to receive other information.

The processor 1304 in the fifth node 115 may be further configured to transmit or send information to e.g., the first node 111, the first group of second nodes 112, the other one or more third nodes 113, the fourth node 114, the fifth node 115, the first plurality of radio networks nodes 141, the second plurality of radio networks nodes 142, the first plurality of devices 131, the second plurality of devices 132, another node or device and/or another structure in the communications system 100, through a sending port 1307, which may be in communication with the processor 1304, and the memory 1305.

Those skilled in the art will also appreciate that the units 1301-1303 described above may refer to a combination of analog and digital circuits, and/or one or more processors configured with software and/or firmware, e.g., stored in memory, that, when executed by the one or more processors such as the processor 1304, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1301-1303 described above may be the processor 1304 of the fifth node 115, or an application running on such processor.

Thus, the methods according to the embodiments described herein for the fifth node 115 may be respectively implemented by means of a computer program 1308 product, comprising instructions, i.e., software code portions, which, when executed on at least one processor 1304, cause the at least one processor 1304 to carry out the actions described herein, as performed by the fifth node 115. The computer program 1308 product may be stored on a computer-readable storage medium 1309. The computer-readable storage medium 1309, having stored thereon the computer program 1308, may comprise instructions which, when executed on at least one processor 1304, cause the at least one processor 1304 to carry out the actions described herein, as performed by the fifth node 115. In some embodiments, the computer-readable storage medium 1309 may be a non-transitory computer-readable storage medium, such as a CD ROM disc, a memory stick, or stored in the cloud space. In other embodiments, the computer program 1308 product may be stored on a carrier containing the computer program, wherein the carrier is one of an electronic signal, optical signal, radio signal, or the computer-readable storage medium 1309, as described above.

The fifth node 115 may comprise an interface unit to facilitate communications between the fifth node 115 and other nodes or devices, e.g., the first node 111, the first group of second nodes 112, the other one or more third nodes 113, the fourth node 114, the fifth node 115, the first plurality of radio networks nodes 141, the second plurality of radio networks nodes 142, the first plurality of devices 131, the second plurality of devices 132, another node or device and/or another structure in the communications system 100. In some particular examples, the interface may, for example, include a transceiver configured to transmit and receive radio signals over an air interface in accordance with a suitable standard.

In other embodiments, the fifth node 115 may comprise the following arrangement depicted in FIG. 13b. The fifth node 115 may comprise a processing circuitry 1304, e.g., one or more processors such as the processor 1304, in the fifth node 115 and the memory 1305. The fifth node 115 may also comprise a radio circuitry 1310, which may comprise e.g., the receiving port 1306 and the sending port 1307. The processing circuitry 1304 may be configured to, or operable to, perform the method actions according to FIG. 9 and/or FIG. 10, in a similar manner as that described in relation to FIG. 13a. The radio circuitry 1310 may be configured to set up and maintain at least a wireless connection with the first node 111, the first group of second nodes 112, the other one or more third nodes 113, the fourth node 114, the fifth node 115, the first plurality of radio networks nodes 141, the second plurality of radio networks nodes 142, the first plurality of devices 131, the second plurality of devices 132, another node or device and/or another structure in the communications system 100.

Hence, embodiments herein also relate to the fifth node 115 operative for handling the distributed machine-learning or federated learning process configured to be ongoing, the fifth node 115 being operative to operate in the communications system 100. The fifth node 115 may comprise the processing circuitry 1304 and the memory 1305, said memory 1305 containing instructions executable by said processing circuitry 1304, whereby the fifth node 115 is further operative to perform the actions described herein in relation to the fifth node 115, e.g., in FIG. 9 and/or FIG. 10.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

[1] J. Liu, J. Huang, Y. Zhou, X. Li, S. Ji, H. Xiong, and D. Dou, “From distributed machine learning to federated learning: A survey.” arXiv preprint arXiv: 2104.14362v2, May 10, 2021.
[2] S. Hu, X. Chen, W. Ni, E. Hossain, and X. Wang, “Distributed machine learning for wireless communication networks: Techniques, architectures, and applications.” IEEE Communications Surveys & Tutorials, vol. 23, No. 3, Third Quarter 2021.
[3] Q. Li, Z. Wen, Z. Wu, S. Hu, N. Wang, Y. Li, X. Lu, and B. He, “A survey of federated learning system: Vision, hype and reality for data privacy and protection.” arXiv preprint arXiv: 1907.09693v6, Jul. 1, 2021.
[4] Q. Yang, Y. Liu, T. Chen, and Y. Tong, “Federated machine learning: Concept and applications.” arXiv preprint arXiv: 1902.04885v1, Feb. 13, 2019.
[5] H. McMahan, E. Moore, D. Ramage, S. Hampson, et al. “Communication-efficient learning of deep networks from decentralized data.” arXiv preprint arXiv: 1602.05629, 2016.
[8] TS 23.288 v. 17.3.0.
[9] TR 23.700-91 v. 17.0.0.
TS 23.501 v. 17.3.0.
TS 23.502 v. 17.3.0.

1. A computer-implemented method, performed by a first node, for handling an ongoing distributed machine-learning or federated learning process for which the first node acts an aggregator of data or analytics from a first group of second nodes, the first node operating in a communications system, the method comprising:
obtaining, one or more first indications about one or more third nodes operating in the communications system, the one or more first indications comprising respective information about the one or more third nodes, the respective information indicating that the one or more third nodes are eligible to be selected to participate in the ongoing distributed machine-learning or federated learning process, wherein the one or more first indications are obtained during the ongoing distributed machine-learning or federated learning process, and
providing, to a fourth node operating in the communications system, an output of the ongoing distributed machine-learning or federated learning process based on the obtained one or more first indications.

2. The computer-implemented method according to claim 1, wherein that the output is based on the obtained one or more first indications comprises:
selecting, based on the received respective one or more first indications, from the first group of second nodes and the one or more third nodes, one or more selected nodes to continue the ongoing distributed machine-learning or federated learning process, wherein the ongoing distributed machine-learning or federated learning process is continued using the one or more selected nodes, and wherein the output is based on the ongoing distributed machine-learning or federated learning process, continued using the one or more selected nodes, and
sending a respective second indication to the one or more selected nodes, the respective second indication indicating to the one or more selected nodes that they have been selected to continue the ongoing distributed machine-learning or federated learning.

3. The computer-implemented method according to claim 2, wherein that the output is based on the obtained one or more first indications comprises:
determining, based on the obtained respective one or more first indications, whether the ongoing distributed machine-learning or federated learning process is to be continued with any of the one or more selected nodes, and wherein the output is based on a result of the determination.

4.-5. (canceled)

6. The computer-implemented method according to claim 1, wherein the respective information comprised in the one or more first indications indicates, one or more of:
a respective willingness to join the ongoing distributed machine-learning or federated learning process,
a respective first capability to complete one or more training tasks of the ongoing distributed machine-learning or federated learning process,
one or more respective characteristics of available data to a respective third node,
a respective supported machine-learning framework,
a respective time availability to participate in the ongoing distributed machine-learning or federated learning process.

7. (canceled)

8. The computer-implemented method according to claim 1, wherein the obtaining is performed one of:
directly from, respectively, the one or more third nodes, and
via a fifth node operating in the communications system the one or more third nodes have previously registered with.

9. The computer-implemented method according to claim 8, further comprising:
registering with the fifth node first information indicating the ongoing distributed machine-learning or federated learning process, wherein the first information indicates at least one of:
an identifier of the ongoing distributed machine-learning or federated learning process, and
second information about the first group of second nodes used for the ongoing distributed machine-learning or federated learning process,
and wherein the obtaining of the one or more first indications is based on the registered first information.

10. The computer-implemented method according to claim 1, further comprising:
sending a prior indication to the fifth node, the prior indication requesting the one or more first indications, and wherein the obtaining of the one or more first indications is based on the sent prior indication.

11. The computer-implemented method according to claim 8, wherein the communications system is a Fifth Generation, 5G, network, and wherein:
the first node is a server Network Data Analytics Function, NWDAF,
the first group of second nodes are client NWDAFs,
the one or more third nodes are other client NWDAFs,
the fourth node is a NWDAF service consumer, and
the fifth node is a distributed machine-learning or federated learning control function, DLCF.

12. A computer-implemented method, performed by a third node, for handling an ongoing distributed machine-learning or federated learning process, the third node operating in a communications system, the method comprising:
providing a first indication about the third node to one of a first node and a fifth node operating in the communications system, wherein the first node acts an aggregator of data or analytics from a first group of second nodes in the ongoing distributed machine-learning or federated learning process, the first indication comprising respective information about the third node, the respective information indicating that the third node is eligible to be selected to participate in the ongoing distributed machine-learning or federated learning process, and
wherein the first indication is provided during the ongoing distributed machine-learning or federated learning process.

13. The computer-implemented method according to claim 12, wherein the third node is selected, from the first group of second nodes and one or more third nodes comprising the third node, based on the provided first indication, to be comprised in one or more selected nodes to continue the ongoing distributed machine-learning or federated learning process, and wherein the method further comprises:
receiving a respective second indication from the first node, the respective second indication indicating the third node has been selected to continue the ongoing distributed machine-learning or federated learning.

14. The computer-implemented method according to claim 13, wherein the ongoing distributed machine-learning or federated learning process is continued using the one or more selected nodes, and wherein an output of the ongoing distributed machine-learning or federated learning process is based on the ongoing distributed machine-learning or federated learning process, continued using the one or more selected nodes.

15. The computer-implemented method according to claim 12, wherein the first group of second nodes is used as a first group of clients and wherein the third node is selected to be used as part of a second group of clients to continue the ongoing distributed machine-learning or federated learning process.

16. The computer-implemented method according to claim 12, wherein the respective information indicates one or more of:
a respective willingness to join the ongoing distributed machine-learning or federated learning process,
a respective first capability to complete one or more training tasks of the ongoing distributed machine-learning or federated learning process,
one or more respective characteristics of available data to the third node,
a respective supported machine-learning framework,
a respective time availability to participate in the ongoing distributed machine-learning or federated learning process.

17. The computer-implemented method according to claim 16, wherein providing the first indication comprises registering the respective information with the fifth node, and wherein the receiving of the respective second indication is based on the registered respective information.

18.-20. (canceled)

21. The computer-implemented method according to claim 12, wherein the communications system is a Fifth Generation, 5G, network, and wherein:
the first node is a server Network Data Analytics Function, NWDAF,
the first group of second nodes are client NWDAFs,
the third node is another client NWDAFs, and
the fifth node is a distributed machine-learning or federated learning control function, DLCF.

22. A computer-implemented method, performed by a fifth node, for handling an ongoing distributed machine-learning or federated learning process, the fifth node operating in a communications system, the method comprising:
obtaining one or more first indications from one or more third nodes operating in the communications system, the one or more first indications comprising respective information indicating that the one or more third nodes are eligible to be selected to participate in the ongoing distributed machine-learning or federated learning process, wherein the one or more first indications are obtained during the ongoing distributed machine-learning or federated learning process, and
providing the one or more first indications to a first node operating in the communications system, wherein the first node acts an aggregator of data or analytics from a first group of second nodes for the ongoing distributed machine-learning or federated learning process, and wherein the one or more first indications are provided during the ongoing distributed machine-learning or federated learning process.

23. The computer-implemented method according to claim 22, wherein the respective information indicates, one or more of:
a respective willingness to join the ongoing distributed machine-learning or federated learning process,
a respective first capability to complete one or more training tasks of the ongoing distributed machine-learning or federated learning process,
one or more respective characteristics of available data to a respective third node,
a respective supported machine-learning framework,
a respective time availability to participate in the ongoing distributed machine-learning or federated learning process.

24. The computer-implemented method according to claim 22, wherein obtaining the one or more first indications comprises registering the respective information from the one or more third nodes, and wherein the providing of the one or more first indications is based on the registered respective information.

25.-27. (canceled)

28. The computer-implemented method according to claim 22, wherein the communications system is a Fifth Generation, 5G, network, and wherein:
the first node is a server Network Data Analytics Function, NWDAF,
the first group of second nodes are client NWDAFs,
the one or more third nodes are other client NWDAFs, and
the fifth node is a distributed machine-learning or federated learning control function, DLCF.

29. A first node, for handling a distributed machine-learning or federated learning process configured to be ongoing, for which the first node is configured to act an aggregator of data or analytics from a first group of second nodes, the first node being further configured to operate in a communications system, the first node being further configured to:
obtain, one or more first indications about one or more third nodes configured to operate in the communications system, the one or more first indications being configured to comprise respective information about the one or more third nodes, the respective information being configured to indicate that the one or more third nodes are eligible to be selected to participate in the distributed machine-learning or federated learning process configured to be ongoing, wherein the one or more first indications are configured to be obtained during the distributed machine-learning or federated learning process configured to be ongoing, and
provide, to a fourth node configured to operate in the communications system, an output of the distributed machine-learning or federated learning process configured to be ongoing, based on the one or more first indications configured to be obtained.

30.-39. (canceled)

40. A third node, for handling a distributed machine-learning or federated learning process configured to be ongoing, the third node being configured to operate in a communications system, the third node being further configured to:
provide a first indication about the third node to one of a first node and a fifth node configured to operate in the communications system, wherein the first node is configured to act as an aggregator of data or analytics from a first group of second nodes in the distributed machine-learning or federated learning process configured to be ongoing, the first indication being configured to comprise respective information about the third node, the respective information configured to indicate that the third node is eligible to be selected to participate in the distributed machine-learning or federated learning process configured to be ongoing, and
wherein the first indication is configured to be provided during the distributed machine-learning or federated learning process configured to be ongoing.

41.-49. (canceled)

50. A fifth node, for handling a distributed machine-learning or federated learning process configured to be ongoing, the fifth node being configured to operate in a communications system, the fifth node being further configured to:
obtain one or more first indications from one or more third nodes configured to operate in the communications system, the one or more first indications being configured to comprise respective information configured to indicate that the one or more third nodes are eligible to be selected to participate in the distributed machine-learning or federated learning process configured to be ongoing, wherein the one or more first indications are configured to be obtained during the distributed machine-learning or federated learning process configured to be ongoing, and
provide the one or more first indications to a first node configured to operate in the communications system, wherein the first node is configured to act as an aggregator of data or analytics from a first group of second nodes for the distributed machine-learning or federated learning process configured to be ongoing, and wherein the one or more first indications are configured to be provided during the distributed machine-learning or federated learning process configured to be ongoing.

51.-56. (canceled)
